(19) United States
(12) Patent Application Publication
(10) Pub. No.: US 2026/0333279 A1
(43) Pub. Date: Oct. 22, 2026

(54) DRX CONFIGURATION FOR SIDELINK POSITIONING

(71) Applicant: Lenovo (Singapore) Pte. Ltd., Singapore (SG)

(72) Inventors: Joachim Löhr, Wiesbaden (DE); Robin Rajan Thomas, Bad Nauheim (DE); Karthikeyan Ganesan, Nauheim (DE); Hyung-Nam Choi, Ottobrunn (DE); Prateek Basu Mallick, Dreieich (DE); Alexander Golitschek Edler von Elbwart, Darmstadt (DE)

(21) Appl. No.: 19/113,890

(22) PCT Filed: Sep. 28, 2023
(86) PCT No.: PCT/IB2023/059720

§ 371 Date: Mar. 20, 2025

Related U.S. Application Data
(60) Provisional application No. 63/410,940, filed on Sep. 28, 2022.

(51) Int. Cl. H04W 64/00; H04W 76/28; H04W 92/18

(52) U.S. Cl. CPC H04W 64/00; H04W 76/28; H04W 92/18

(57) ABSTRACT

Various aspects of the present disclosure relate to DRX configuration adaptation for SL positioning. A UE may be configured to participate in a positioning session with a set of UEs receive a CSI reporting setting and to configure a DRX configuration comprising a DRX active time. The UE may be configured to receive signaling information from at least one UE of the set of UEs and to adjust the DRX active time to include time periods corresponding to the transmission of SL-PRS in response to the reception of the signaling information, where the signaling information comprises timing information for transmission of SL-PRS.

### TECHNICAL FIELD

The present disclosure relates to wireless communications, and more specifically to adjusting a discontinuous reception (“DRX”) configuration for transmission of sidelink positioning reference signals (“SL-PRS”).

### BACKGROUND

A wireless communications system may include one or multiple network communication devices, such as base stations, which may be otherwise known as an evolved NodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) Radio Access Technology (RAT), fourth generation (4G) RAT, fifth generation (5G) RAT, among other suitable RATs beyond 5G (e.g., sixth generation (6G)).

Sidelink communication refers to peer-to-peer communication directly between User Equipment (“UE”) devices. Accordingly, the UEs communicate with one another without the communications being relayed via the mobile network (i.e., without the need of a base station).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or Cor AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may include a UE participating in a positioning session with a set of UEs and configuring a DRX configuration comprising a DRX active time. The method and apparatuses described herein may further include the UE receiving signaling information from at least one UE of the set of UEs and adjusting the DRX active time to include time periods corresponding to the transmission of SL-PRS in response to the reception of the signaling information, where the signaling information comprises timing information for transmission of SL-PRS.

Some implementations of the method and apparatuses described herein may further include a UE initiating a positioning session with a set of UEs and configuring a DRX configuration comprising a DRX active time. The method and apparatuses described herein may further include the UE transmitting signaling information to at least one UE of the set of UEs and adjusting the DRX active time to include time periods corresponding to the signaling information and a reception of SL-PRS, where the signaling information comprises a request for transmission of SL-PRS.

### BRIEF DESCRIPTION OF THE DRAWINGS

FIG. 1 illustrates an example of a wireless communication system in accordance with aspects of the present disclosure.

FIG. 2 illustrates an example of a Third Generation Partnership Project (3GPP) New Radio (NR) protocol stack showing different protocol layers in the UE and network, in accordance with aspects of the present disclosure.

FIG. 3 illustrates an example of a SL protocol stack showing different protocol layers in a pair of UEs, in accordance with aspects of the present disclosure.

FIG. 4 illustrates an example of a timing diagram for a Multi-cell Round Trip Time (Multi-RTT) measurement procedure, in accordance with aspects of the present disclosure.

FIG. 5 illustrates an example of a range estimation using a single unit Round Trip Time (RTT) positioning framework, in accordance with aspects of the present disclosure.

FIG. 6A illustrates an example of a relative positioning, variable coordinate system, in accordance with aspects of the present disclosure.

FIG. 6B illustrates an example of a relative positioning, variable and moving coordinate system, in accordance with aspects of the present disclosure.

FIG. 6C illustrates an example of an absolute positioning, fixed coordinate system, in accordance with aspects of the present disclosure.

FIG. 7 illustrates an example of a beam-based positioning framework, in accordance with aspects of the present disclosure.

FIG. 8 illustrates an example of a user equipment (UE) 800, in accordance with aspects of the present disclosure.

FIG. 9 illustrates an example of a processor 900, in accordance with aspects of the present disclosure.

FIG. 10 illustrates an example of a network equipment (NE) 1000, in accordance with aspects of the present disclosure.

FIG. 11 illustrates a flowchart of a first method for DRX configuration adaptation for SL positioning performed by a Rx UE in accordance with aspects of the present disclosure.

FIG. 12 illustrates a flowchart of a second method for DRX configuration adaptation for SL positioning performed by a Rx UE in accordance with aspects of the present disclosure.

FIG. 13 illustrates a flowchart of a third method for DRX configuration adaptation for SL positioning performed by a Rx UE in accordance with aspects of the present disclosure.

FIG. 14 illustrates a flowchart of a fourth method for DRX configuration adaptation for SL positioning performed by a Tx UE in accordance with aspects of the present disclosure.

FIG. 15 illustrates a flowchart of a fifth method for DRX configuration adaptation for SL positioning performed by a Tx UE in accordance with aspects of the present disclosure.

FIG. 16 illustrates a flowchart of a sixth method for DRX configuration adaptation for SL positioning performed by a NE in accordance with aspects of the present disclosure.

FIG. 17 illustrates a flowchart of a seventh method for DRX configuration adaptation for SL positioning performed by a NE in accordance with aspects of the present disclosure.

### DETAILED DESCRIPTION

Generally, the present disclosure describes systems, methods, and apparatuses for reporting CSI feedback with CQI values. In certain embodiments, the methods may be performed using computer-executable code embedded on a computer-readable medium. In certain embodiments, an apparatus or system may include a computer-readable medium containing computer-readable code which, when executed by a processor, causes the apparatus or system to perform at least a portion of the below described solutions.

In wireless communications networks, CSI feedback is reported by the UE to the network, where the CSI feedback can take multiple forms based on the CSI feedback report size, time and frequency granularity, or other CSI reporting settings.

For CSI reporting in 3GPP NR Release 16 specification (Rel-16), two types of codebooks are defined. The NR Type-I codebook uses multiple predefined matrices from which a selection is made by User Equipment (UE) report and/or RRC Configuration. In contrast, the NR Type-II codebook is not based on a predefined table, but it is based on a specifically designed mathematical formula with a several parameters. The parameters in the formula are determined by RRC Configuration and/or UE report. The NR Type-II codebook is based on a more detailed CSI report and supports Multi-User Multiple-Input, Multiple-Output (MU-MIMO) communication.

In NR Rel-16, high-resolution CSI feedback report (i.e., Type-II) was specified, where the frequency granularity of the CSI feedback can be indirectly parametrized. For the 3GPP NR Rel-16 Type-II codebook with high resolution, the number of Precoding Matrix Indicator (PMI) bits fed back from the UE in the next-generation node-B (gNB) via Uplink Control Information (UCI) can be very large (>1000 bits at large bandwidth), even for a single-point transmission. The purpose of multi-panel transmission is to improve the spectral efficiency, as well as the reliability and robustness of the connection in different scenarios, and it covers both ideal and nonideal backhaul. For increasing the reliability using multi-panel transmission, ultra-reliable low-latency communication (URLLC) under multi-panel transmission was agreed, where the UE can be served by multiple Transmit-Receive Points (TRPs) forming a coordination cluster, possibly connected to a central processing unit.

In addition, CSI feedback enhancements corresponding to scenarios in which the UE speed is relatively high are being studied. While one proposal is to report multiple CSI reports, each including Rank Indicator (RI) and/or PMI and/or CQI with lower periodicity, i.e., more frequent reporting, to account for the faster channel variations at high speed, a drawback to this proposal is that larger CSI feedback overhead and higher complexity at the UE to report/compute the multiple CSI reports. While another proposal is to report a single CQI value corresponding to a time interval that is equivalent to the legacy CSI reporting periodicity values, a drawback to this proposal is that a single CQI value may fail to capture the channel variations within a single CSI reporting periodicity value.

In order to accommodate such high-speed scenarios while maintaining similar quality of service, a modified CSI framework, including measurement and reporting, are needed. At high speed, the channel coherence time is expected to fall below conventional CSI reporting periodicity values, and hence the channel quality may vary within one CSI reporting interval. Hence, enhancements to CQI format may be needed. CQI enhancements are proposed for CSI framework under high speed. The proposed solutions comprise the following:

According to a first solution, multiple CQI values are fed back within a CSI report, with a reference CQI value reported with high resolution, e.g., subband (SB) format, and subsequent CQI values reported with lower resolution, e.g., wideband (WB) format.

According to a second solution, the UE reports multiple CQI values with a lower periodicity value, i.e., more frequent reporting, compared with PMI/RI reporting periodicity.

According to a third solution, only two CQI values are fed back within a CSI report, with a configured (and/or reported and/or indicated) extrapolation method to infer the channel quality in intervals other than the two reference intervals corresponding to the two CQI values.

Aspects of the present disclosure are described in the context of a wireless communications system.

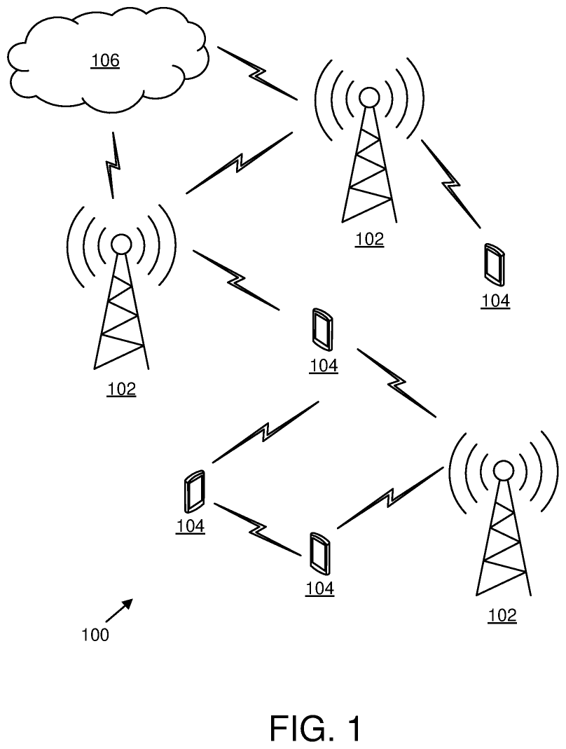

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

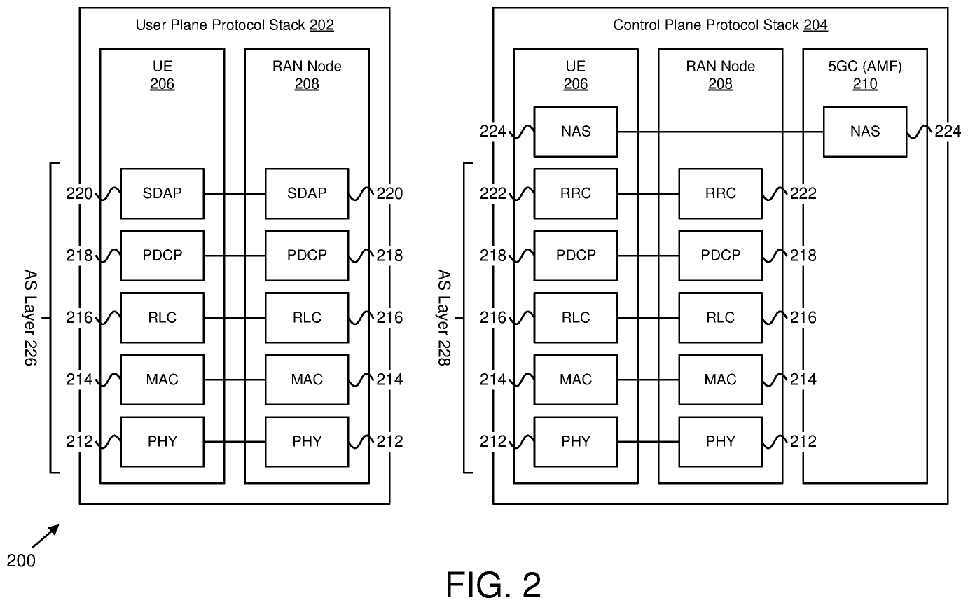

FIG. 2 illustrates an example of a NR protocol stack 200, in accordance with aspects of the present disclosure. While FIG. 2 shows a UE 206, a RAN node 208, and a 5G core network (5GC) 210 (e.g., comprising at least an AMF), these are representative of a set of UEs 104 interacting with an NE 102 (e.g., base station) and a CN 106. As depicted, the NR protocol stack 200 comprises a User Plane protocol stack 202 and a Control Plane protocol stack 204. The User Plane protocol stack 202 includes a physical (PHY) layer 212, a Medium Access Control (MAC) sublayer 214, a Radio Link Control (RLC) sublayer 216, a Packet Data Convergence Protocol (PDCP) sublayer 218, and a Service Data Adaptation Protocol (SDAP) layer 220. The Control Plane protocol stack 204 includes a PHY layer 212, a MAC sublayer 214, a RLC sublayer 216, and a PDCP sublayer 218. The Control Plane protocol stack 204 also includes a Radio Resource Control (RRC) layer 222 and a Non-Access Stratum (NAS) layer 224.

The AS layer 226 (also referred to as “AS protocol stack”) for the User Plane protocol stack 202 consists of at least SDAP, PDCP, RLC and MAC sublayers, and the physical layer. The AS layer 228 for the Control Plane protocol stack 204 consists of at least RRC, PDCP, RLC and MAC sublayers, and the physical layer. The Layer-1 (L1) includes the PHY layer 212. The Layer-2 (L2) is split into the SDAP layer 220, PDCP sublayer 218, RLC sublayer 216, and MAC sublayer 214. The Layer-3 (L3) includes the RRC layer 222 and the NAS layer 224 for the control plane and includes, e.g., an IP layer and/or PDU Layer (not depicted) for the user plane. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In certain embodiments, the PHY layer 212 may send an indication of beam failure to a MAC entity at the MAC sublayer 214. The MAC sublayer 214 offers logical channels to the RLC sublayer 216. The RLC sublayer 216 offers RLC channels to the PDCP sublayer 218. The PDCP sublayer 218 offers radio bearers to the SDAP sublayer 220 and/or RRC layer 222. The SDAP sublayer 220 offers QoS flows to the core network (e.g., 5GC). The RRC layer 222 provides for the addition, modification, and release of Carrier Aggregation and/or Dual Connectivity. The RRC layer 222 also manages the establishment, configuration, maintenance, and release of Signaling Radio Bearers (SRBs) and Data Radio Bearers (DRBs).

The NAS layer 224 is between the UE 206 and an AMF in the 5GC 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 208) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the NR protocol stack. Its connection to the PHY layer 212 below is through transport channels, and the connection to the RLC sublayer 216 above is through logical channels. The MAC sublayer 214 therefore performs multiplexing and demultiplexing between logical channels and transport channels: the MAC sublayer 214 in the transmitting side constructs MAC PDUs (also known as Transport Blocks (TBs)) from MAC Service Data Units (SDUs) received through logical channels, and the MAC sublayer 214 in the receiving side recovers MAC SDUs from MAC PDUs received through transport channels.

The MAC sublayer 214 provides a data transfer service for the RLC sublayer 216 through logical channels, which are either control logical channels which carry control data (e.g., RRC signaling) or traffic logical channels which carry user plane data. On the other hand, the data from the MAC sublayer 214 is exchanged with the PHY layer 212 through transport channels, which are classified as UL or DL. Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., Adaptive Modulation and Coding (AMC)), power control, cell search and random access (for initial synchronization and handover purposes) and other measurements (inside the 3GPP system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of Physical Resource Blocks (PRBs), etc.

Note that an LTE protocol stack comprises similar structure to the NR protocol stack 200, with the differences that the LTE protocol stack lacks the SDAP sublayer 220 in the AS layer 226, that an EPC replaces the 5GC 510, and that the NAS layer 224 is between the UE 206 and an MME in the EPC. Also note that the present disclosure distinguishes between a protocol layer (such as the aforementioned PHY layer 212, MAC sublayer 214, RLC sublayer 216, PDCP sublayer 218, SDAP layer 240, RRC layer 222 and NAS layer 224) and a transmission layer in MIMO communication (also referred to as a “MIMO layer” or a “data stream”).

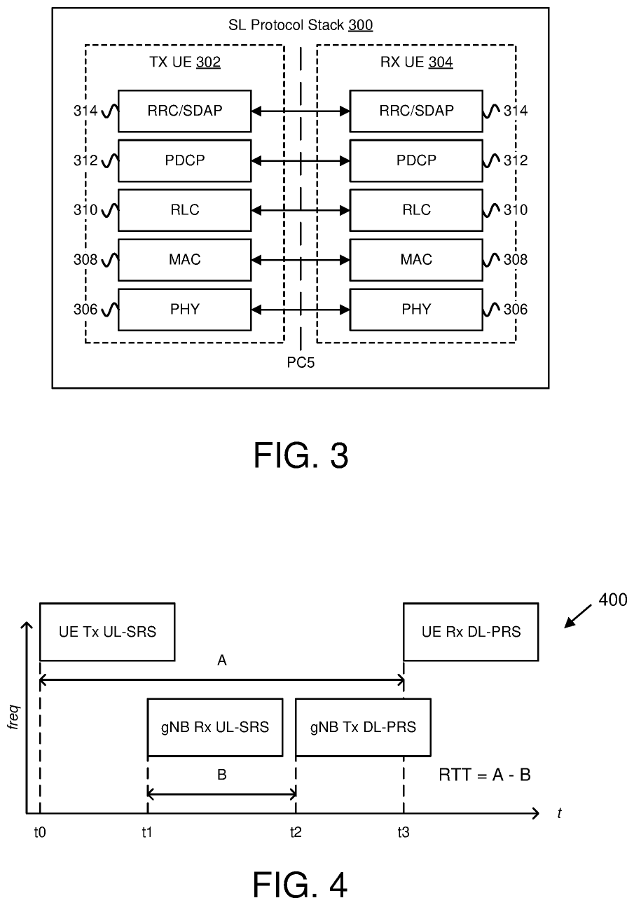

FIG. 3 depicts a SL protocol stack 300, according to embodiments of the disclosure. While FIG. 3 shows a transmitting SL UE 302 (denoted “TX UE”) and a receiving SL UE 304 (denoted “RX UE”), these are representative of a set of UEs communicating peer-to-peer via a PC5 interface, and other embodiments may involve different UEs. As depicted, the SL protocol stack 300 includes a physical layer 306, a MAC sublayer 308, a RLC sublayer 310, a PDCP sublayer 312, and RRC and SDAP layers (depicted as combined element “RRC/SDAP” 314), for the control plane and user plane, respectively. The physical layer 306, the MAC sublayer 308, the RLC sublayer 310, the PDCP sublayer 312, and the RRC/SDAP layers 314 may perform substantially the same functions described above with reference to the NR protocol stack 200, but supporting UE-to-UE communications between the TX UE 302 and the RX UE 304.

The AS protocol stack for the control plane in the SL protocol stack 300 consists of at least RRC, PDCP, RLC and MAC sublayers, and the physical layer. The AS protocol stack for the user plane in the SL protocol stack 300 consists of at least SDAP, PDCP, RLC and MAC sublayers, and the physical layer. The L2 is split into the SDAP, PDCP, RLC and MAC sublayers. The L3 includes the RRC sublayer for the control plane and includes, e.g., an IP layer for the user plane. L1 and L2 are referred to as “lower layers”, while L3 and above (e.g., transport layer, V2X layer, application layer) are referred to as “higher layers” or “upper layers.”

Regarding positioning performance requirements and positioning methods, for Rel-17, the different positioning requirements are especially stringent with respect to accuracy, latency, and reliability.

The supported positioning techniques in Rel-16 are listed in Table 1, below. These techniques are defined in 3GPP Technical Specification (TS) 38.306.

TABLE 1
Supported Rel-16 UE positioning methods

| | | UE- | NG- | Secure User- |
|---|---|---|---|---|
| | UE- | assisted, | RAN node | Plane Location |
| Method | based | LMF-based | assisted | (SUPL) |
| A-GNSS | Yes | Yes | No | Yes (UE-based |
| | | | | and UE-assisted) |
| OTDOA ^{Note1, Note 2} | No | Yes | No | Yes (UE-assisted) |
| E-CID ^{Note 3} | No | Yes | Yes | Yes for E-UTRA |
| | | | | (UE-assisted) |
| Sensor | Yes | Yes | No | No |
| WLAN | Yes | Yes | No | Yes |
| Bluetooth | No | Yes | No | No |
| TBS ^{Note 4} | Yes | Yes | No | Yes (MBS) |
| DL- | Yes | Yes | No | No |
| TDOA | | | | |
| DL-AoD | Yes | Yes | No | No |
| Multi- | No | Yes | Yes | No |
| RTT | | | | |
| NR E- | No | Yes | — | No |
| CID | | | | |
| UL- | No | No | Yes | No |
| TDOA | | | | |
| UL-AoA | No | No | Yes | No |

^{NOTE1}:
This includes Terrestrial Beacon System (TBS) positioning based on PRS
signals.
^{NOTE 2}:
In this version of the specification only Observed Time Difference of Arrival (OTDOA) based on LTE signals is supported.
^{NOTE 3}:
This includes Cell-ID for NR method.
^{NOTE 4}:
In this version of the specification only for TBS positioning based on Metropolitan Beacon System (MBS) signals.

Separate positioning techniques as indicated in Table 1 can be currently configured and performed based on the requirements of the Location Management Function (LMF) and user Equipment (UE) capabilities. The transmission of Positioning Reference Signals (PRS) enables the UE to perform UE positioning-related measurements to enable the computation of a UE's location estimate and are configured per Transmission Reception Point (TRP), where a TRP may transmit one or more beams.

The following RAT-dependent positioning techniques are supported in Rel-16:10 Downlink Time Difference of Arrival (DL-TDOA); Downlink Angle-of-Departure (DL-AoD); Multi-RTT; Enhanced Cell Identity (E-CID); Uplink Time Difference of Arrival (UL-TDOA); Uplink Angle-of-Arrival (UL-AoA).

The DL-TDOA positioning method makes use of the DL Reference Signal Time Difference (RSTD) (and optionally DL PRS Reference Signal Received Power (RSRP)) of downlink signals received from multiple Transmission Points (TPs), at the UE. The UE measures the DL RSTD (and optionally DL PRS RSRP) of the received signals using assistance data received from the positioning server, and the resulting measurements are used along with other configuration information to locate the UE in relation to the neighboring TPs.

The DL-AoD positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

The Multi-RTT positioning method makes use of the UE Rx-Tx measurements and DL PRS RSRP of downlink signals received from multiple TRPs, measured by the UE and the measured gNB Rx-Tx measurements and UL Sounding Reference Signal RSRP (SRS-RSRP) at multiple TRPs of uplink signals transmitted from UE.

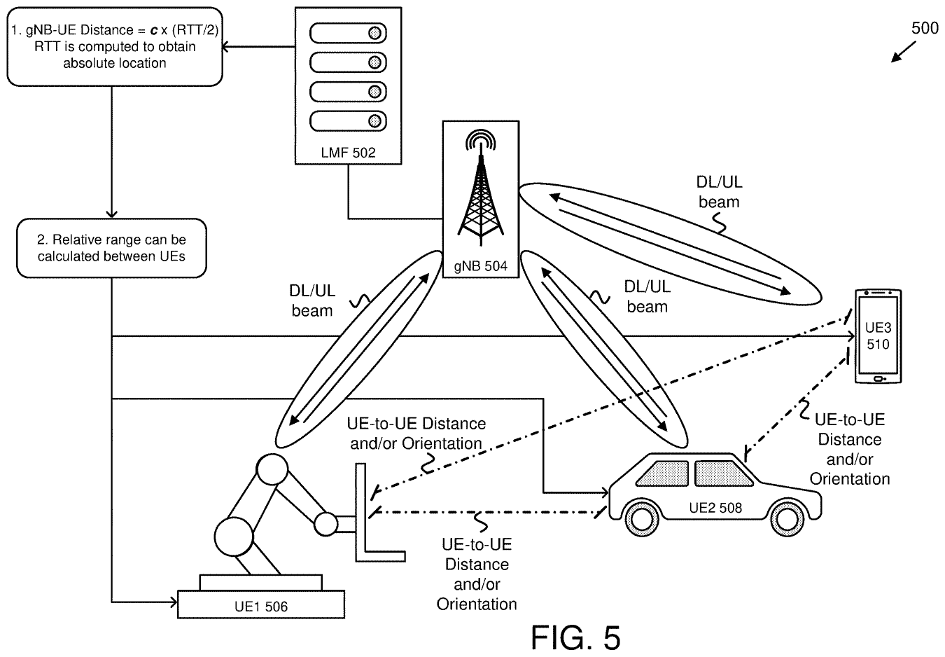

FIG. 4 depicts an exemplary Multi-RTT procedure 400. The UE measures the UE Rx-Tx measurements (and optionally DL PRS RSRP of the received signals) using assistance data received from the positioning server (e.g., LMF server), and the TRPs measure the gNB Rx-Tx measurements (and optionally UL SRS-RSRP of the received signals) using assistance data received from the positioning server. The measurements are used to determine the Round-Trip Time (RTT) at the positioning server which are used to estimate the location of the UE.

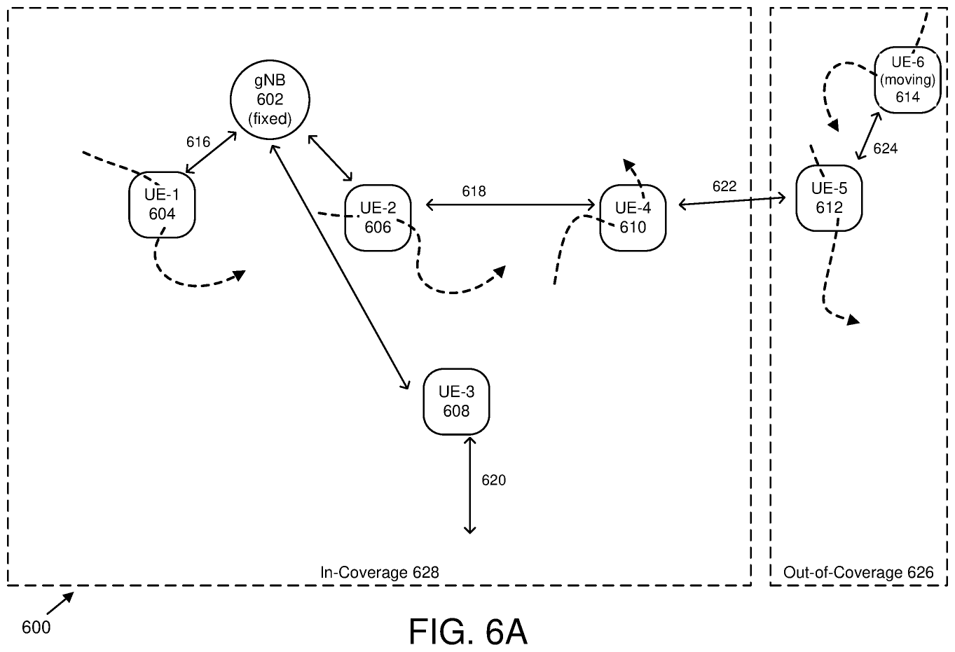

FIG. 5 depicts an example procedure 500 for relative range estimation using RTT positioning techniques. The procedure 500 involves a LMF server 502, a gNB 504, and a plurality of UEs, including a first UE 506 (denoted “UE1”), a second UE 508 (denoted “UE2”), and a third UE 510 (denoted “UE3”). The LMF server 502 may be one embodiment of the LMF 146, the gNB 504 may be one embodiment of the RAN node 208 and/or the NE 102, and the UEs may be embodiments of the UE 206, the TX UE 302 and/or RX UE 304.

At step 1, the gNB-UE distance is determined as half the gNB-UE RTT multiplied by the speed of light. The gNB-UE RTT is computed and used by the LMF server 502 to obtain an absolute location of a UE. Note that the LMF server 502 may use RTT measurements and beam orientation from a single gNB 504 to obtain the absolute UE location. In other embodiments, the LMF server 502 may use RTT measurements from multiple TRPs to obtain the absolute UE location.

At Step 2, the relative range (i.e., UE-to-UE distance) may be calculated between the UEs. Note that the relative UE-to-UE orientations may also be calculated. The UE1 506, UE2 508, and UE3 510 may determine UE-to-UE distances and orientations using the below described SL positioning techniques.

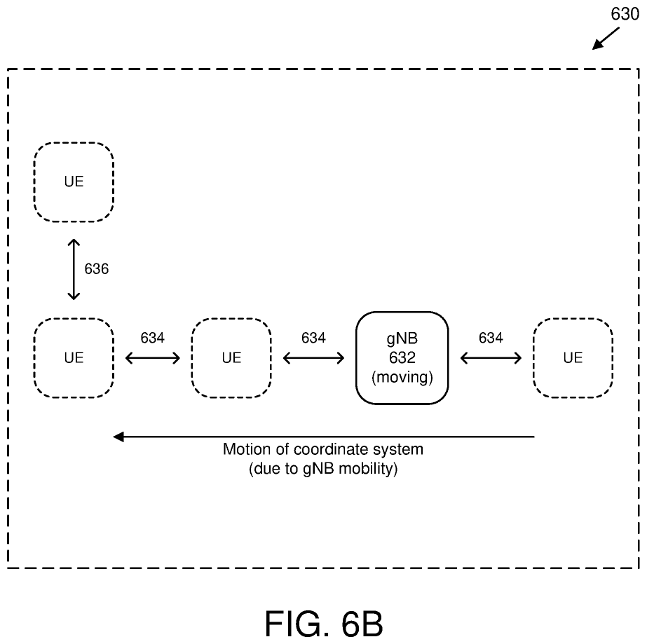

FIGS. 6A-6C depict an overview on absolute and relative positioning using different coordinate systems.

FIG. 6A depicts an example of relative positioning using a variable coordinate system 600. In some embodiments, the coordinate system 600 may be used to determine relative positioning 616 between a first UE (denoted “UE-1”) 604 and a 5G positioning node, such as the gNB 602 (having a fixed location), when the nodes are within 10 m of each other. In some embodiments, the coordinate system 600 may be used to determine relative positioning 618 between two or more UEs, such as the second UE (denoted “UE-2”) 606 and the fourth UE (denoted “UE-4”) 610, when the UEs are within 10 m of each other. In some embodiments, the coordinate system 600 may be used to determine vertical location 620 of a third UE (denoted “UE-3”) 608 in terms of relative height (or depth) to a local ground level. In some embodiments, the coordinate system 600 may be used to determine relative positioning 622 between a fifth UE (denoted “UE-5”) 612 that is out-of-coverage 626 of the network and one or more UEs that are within coverage 628 of the network (e.g., the UE-4), when the UEs are in proximity. Additionally, or alternatively, the coordinate system 600 may be used to determine relative positioning 624 of the UE-5 612 and a sixth UE (denoted “UE-6”) 614 that is also out-of-coverage 626 of the network. The depicted gNBs may be embodiments of the NE 102 and/or the RAN node 208, while the UEs may be embodiments of the UE 104, the UE 206, the TX UE 302 and/or the RX UE 304.

FIG. 6B depicts an example of relative positioning using a variable and moving coordinate system 630. In contrast to the system 600, in the system 630 the gNB 632 is moving, so the coordinate system also moves relative to a fixed ground location. In some embodiments, the coordinate system 630 may be used to determine the relative longitudinal positions 634 (e.g., with accuracy of less than 0.5m error) for UEs supporting V2X application for platooning in proximity. In some embodiments, the coordinate system 630 may be used to determine the relative lateral position 636 (e.g., with accuracy of less than 0.1 m error) between UEs supporting V2X applications. The depicted gNB 632 may be one embodiment of the NE 102 and/or the RAN node 208, while the UEs may be embodiments of the UE 104 and/or UE 206.

FIG. 6C depicts an example of absolute positioning using a fixed coordinate system 640. In contrast to the systems 600 and 630, in the fixed coordinate system 640 there are multiple fixed gNBs. In some embodiments, the coordinate system 640 may be used to determine the absolute location 642 of the UE 644 using a first gNB 646, a second gNB 648 and a third gNB 650. In certain embodiments, the absolute location may be expressed using x, y, and z coordinates. The depicted gNBs may be embodiments of the NE 102 and/or the RAN node 208, while the UE may be one embodiment of the UE 104 and/or UE 206.

Referring again to RAT-dependent positioning techniques, in the E-CID positioning method, the position of a UE 206 is estimated with the knowledge of its serving ng-eNB, gNB and cell and is based on Uu (e.g., LTE) signals. The information about the serving ng-eNB, gNB and cell may be obtained by paging, registration, or other methods. The NR E-CID positioning method refers to techniques which use additional UE measurements and/or NR radio resource and other measurements to improve the UE location estimate using NR signals.

Although the NR E-CID positioning method may utilize some of the same measurements as the measurement control system in the RRC protocol, the UE 206 generally is not expected to make additional measurements for the sole purpose of positioning; i.e., the positioning procedures do not supply a measurement configuration or measurement control message, and the UE 206 reports the measurements that it has available rather than being required to take additional measurement actions.

The UL-TDOA positioning method makes use of the time difference of arrival (and optionally UL SRS-RSRP) at multiple Reception Points of uplink signals transmitted from UE 206. The Reception Points measure the UL TDOA (and optionally UL SRS-RSRP) of the received UL signals using assistance data received from the positioning server, and the resulting measurements are used along with other configuration information to estimate the location of the UE 206.

The UL-AoA positioning method makes use of the measured azimuth and the zenith of arrival at multiple Reception Points of uplink signals transmitted from UE 206. The Reception Points measure Azimuth Angle-of-Arrival (A-AoA) and/or Zenith Angle-of-Arrival (Z-AoA) of the received signals using assistance data received from the positioning server, and the resulting measurements are used along with other configuration information to estimate the location of the UE 206.

RAT-dependent positioning techniques involve the 3GPP RAT and core network entities to perform the position estimation of the UE 206, which are differentiated from RAT-independent positioning techniques which rely on Global Navigation Satellite System (GNSS), Inertial Measurement Unit (IMU) sensor, WLAN and Bluetooth technologies for performing target device (i.e., UE 206) positioning.

The following RAT-Independent positioning techniques are supported in Rel-16: Network-assisted GNSS, Barometric pressure sensor positioning, WLAN positioning, Bluetooth positioning, TBS positioning, Motion sensor positioning.

The network-assisted GNSS (Global Navigation Satellite System) methods make use of UEs 206 that are equipped with radio receivers capable of receiving GNSS signals. In 3GPP specifications the term GNSS encompasses both global and regional/augmentation navigation satellite systems.

Examples of global navigation satellite systems include Global Positioning System (GPS), Modernized GPS, Galileo, GLObal'naya NAvigatsionnaya Sputnikovaya Sistema (GLONASS), and BeiDou Navigation Satellite System (BDS). Regional navigation satellite systems include Quasi Zenith Satellite System (QZSS) while the many augmentation systems, are classified under the generic term of Space Based Augmentation Systems (SBAS) and provide regional augmentation services. In this concept, different GNSSs (e.g., GPS, Galileo, etc.) can be used separately or in combination to determine the location of a UE 206.

Regarding barometric pressure sensor positioning, the barometric pressure sensor method makes use of barometric sensors to determine the vertical component of the position of the UE 206. The UE 206 measures barometric pressure, optionally aided by assistance data, to calculate the vertical component of its location or to send measurements to the positioning server for position calculation. This method should be combined with other positioning methods to determine the 3D position of the UE 206.

Regarding WLAN positioning, the WLAN positioning method makes use of the WLAN measurements (e.g., WLAN AP identifiers and, optionally, signal strength or other measurements) and databases to determine the location of the UE 206. The UE 206 measures received signals from WLAN APs, optionally aided by assistance data, to send measurements to the positioning server for position calculation. Using the measurement results and a references database, the location of the UE 206 is calculated. Alternatively, the UE 206 makes use of WLAN measurements and optionally WLAN AP assistance data provided by the positioning server, to determine its location.

Regarding Bluetooth positioning, the Bluetooth positioning method makes use of Bluetooth measurements (beacon identifiers and optionally other measurements) to determine the location of the UE 206. The UE 206 measures received signals from Bluetooth beacons. Using the measurement results and a references database, the location of the UE 206 is calculated. The Bluetooth methods may be combined with other positioning methods (e.g., WLAN) to improve positioning accuracy of the UE 206.

A TBS consists of a network of ground-based transmitters, broadcasting signals only for positioning purposes. Regarding TBS positioning, the current type of TBS positioning signals are the Metropolitan Beacon System (MBS) signals and PRS. The UE 206 measures received TBS signals, optionally aided by assistance data, to calculate its location or to send measurements to the positioning server for position calculation.

Regarding IMU/motion sensor positioning, this method makes use of different sensors such as accelerometers, gyros, magnetometers, to calculate the displacement of the UE 206. The UE 206 estimates a relative displacement based upon a reference position and/or reference time. The UE 206 sends a report comprising the determined relative displacement which can be used to determine the absolute position. This method should be used with other positioning methods for hybrid positioning.

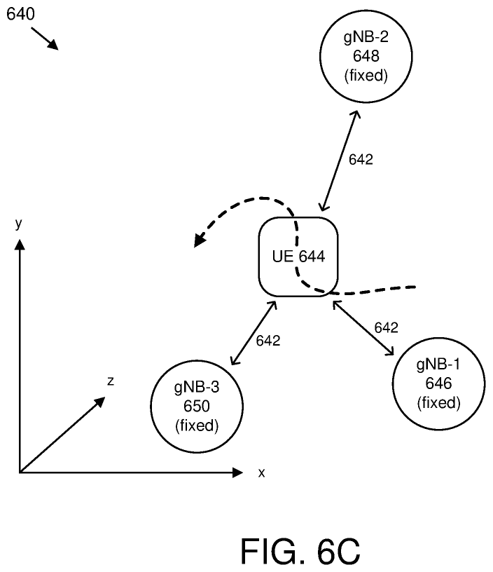

FIG. 7 shows a diagram 700 for NR beam-based positioning measurements and reference signals (RS), according to embodiments of the disclosure. Here, the downlink positioning reference signal (DL-PRS) can be transmitted by different base stations (serving gNB and neighboring gNB) using narrow beams over FR1 (i.e., frequencies from 410 MHz to 7125 MHz) and FR2 (i.e., frequencies from 24.25 GHz to 52.6 GHz), which is relatively different when compared to LTE where the PRS was transmitted across the whole cell. As illustrated in FIG. 7, a UE 206 may receive DL-PRS from a neighboring first gNB/TRP (denoted “gNB1-TRP1”) 704, from a neighboring second gNB (denoted “gNB2-TRP1”) 706, and also from a third gNB/TRP (denoted “gNB3-TRP1”) 708 which is a reference or serving gNB.

Here, the DL-PRS can be locally associated with a DL-PRS Resource Identifier (ID) and Resource Set ID for a base station (i.e., TRP). In the depicted embodiments, each gNB 704, 706, 708 is configured with a first Resource Set ID (depicted as “Resource Set ID #0”) 710 and a second Resource Set ID (depicted as “Resource Set ID #1”) 712. As depicted, the UE 206 receives DL-PRS on transmission beams; here, receiving DL-PRS from the gNB1-TRP1 704 on DL-PRS Resource ID #3 from the second Resource Set ID (Resource Set ID #1) 712, receiving DL-PRS from the gNB2-TRP1 706 on DL-PRS Resource ID #3 from the first Resource Set ID (Resource Set ID #0) 710, and receiving DL-PRS from the gNB3-TRP1 708 on DL-PRS Resource ID #1 from the second Resource Set ID (Resource Set ID #1) 712.

Similarly, UE positioning measurements such as Reference Signal Time Difference (RSTD) and PRS RSRP measurements are made between different beams (e.g., between a different pair of DL PRS resources or DL PRS resource sets)—as opposed to different cells as was the case in LTE. The LMF server 702 uses the UE positioning measurements to determine the UE's location (e.g., absolute location). In addition, there are additional UL positioning methods for the network to exploit in order to compute the target UE's location. Table 2 and Table 3 show the reference signal to measurements mapping required for each of the supported RAT-dependent positioning techniques at the UE and gNB, respectively.

TABLE 2
UE Measurements to enable RAT-dependent
positioning techniques

| | | To facilitate support |
|---|---|---|
| | | of the following |
| DL/UL Reference | | positioning |
| Signals | UE Measurements | techniques |
| Rel. 16 DL PRS | DL RSTD | DL-TDOA |
| Rel. 16 DL PRS | DL PRS RSRP | DL-TDOA, |
| | | DL-AoD, |
| | | Multi-RTT |
| Rel. 16 DL PRS/Rel. 16 | UE Rx − Tx time | Multi-RTT |
| SRS for positioning | difference | |
| Rel. 15 | SS-RSRP (RSRP for | E-CID |
| Synchronization Signal | RRM), SS-RSRQ(for | |
| Block (SSB)/CSI-RS for | RRM), CSI-RSRP | |
| Radio Resource | (for RRM), CSI-RSRQ | |
| Management (RRM) | (for RRM), SS-RSRPB | |
| | (for RRM) | |

TABLE 3
gNB Measurements to enable RAT-
dependent positioning techniques

| | | To facilitate support |
|---|---|---|
| | | of the following |
| DL/UL Reference | | positioning |
| Signals | gNB Measurements | techniques |
| Rel-16 SRS for | UL Relative Time | UL-TDOA |
| positioning | of Arrival (RTOA) | |
| Rel-16 SRS for | UL SRS-RSRP | UL-TDOA, UL-AoA, |
| positioning | | Multi-RTT |
| Rel-16 SRS for | gNB Rx − Tx time | Multi-RTT |
| positioning, Rel-16 | difference | |
| DL PRS | | |
| Rel-16 SRS for | A-AoA and Z-AoA | UL-AoA, Multi-RTT |
| positioning, | | |

Regarding RAT-dependent Positioning Measurements, the different DL measurements including DL PRS-RSRP, DL RSTD and UE Rx-Tx Time Difference required for the supported RAT-dependent positioning techniques are shown in Table 4. The following measurement configurations are specified as follows: A) 4 Pair of DL RSTD measurements can be performed per pair of cells (each measurement is performed between a different pair of DL PRS Resources/Resource Sets with a single reference timing); B) 8 DL PRS RSRP measurements can be performed on different DL PRS resources from the same cell.

TABLE 4
DL Measurements required for DL-based positioning techniques

DL PRS reference signal received power (RSRP)

| | |
|---|---|
| Definition | DL PRS reference signal received power (DL PRS-RSRP), is defined as the |
| | linear average over the power contributions (in [W]) of the resource elements that |
| | carry DL PRS reference signals configured for RSRP measurements within the |
| | considered measurement frequency bandwidth. |
| | For FR1, the reference point for the DL PRS-RSRP shall be the antenna |
| | connector of the UE. For FR2, DL PRS-RSRP shall be measured based on the |
| | combined signal from antenna elements corresponding to a given receiver branch. |
| | For FR1 and FR2, if receiver diversity is in use by the UE, the reported DL PRS- |
| | RSRP value shall not be lower than the corresponding DL PRS-RSRP of any of the |
| | individual receiver branches. |
| Applicable | RRC_CONNECTED intra-frequency, |
| for | RRC_CONNECTED inter-frequency |

DL reference signal time difference (DL RSTD)

| | |
|---|---|
| Definition | DL reference signal time difference (DL RSTD) is the DL relative timing |
| | difference between the positioning node j and the reference positioning node i, |
| | defined as T_{SubframeRxj} − T_{SubframeRxi}, |
| | Where: |
| | T_{SubframeRxj} is the time when the UE receives the start of one subframe from |
| | positioning node j. |
| | T_{SubframeRxi} is the time when the UE receives the corresponding start of one |
| | subframe from positioning node i that is closest in time to the subframe received |
| | from positioning node j. |
| | Multiple DL PRS resources can be used to determine the start of one |
| | subframe from a positioning node. |
| | For FR1, the reference point for the DL RSTD shall be the antenna |
| | connector of the UE. For FR2, the reference point for the DL RSTD shall be the |
| | antenna of the UE. |
| Applicable | RRC_CONNECTED intra-frequency |
| for | RRC_CONNECTED inter-frequency |

UE Rx − Tx time difference

| | |
|---|---|
| Definition | The UE Rx − Tx time difference is defined as T_{UE-RX} − T_{UE-TX} |
| | Where: |
| | T_{UE-RX} is the UE received timing of downlink subframe #i from a |
| | positioning node, defined by the first detected path in time. |
| | T_{UE-TX} is the UE transmit timing of uplink subframe #j that is closest in |
| | time to the subframe #i received from the positioning node. |
| | Multiple DL PRS resources can be used to determine the start of one |
| | subframe of the first arrival path of the positioning node. |
| | For FR1, the reference point for T_{UE-RX} measurement shall be the Rx |
| | antenna connector of the UE and the reference point for T_{UE-TX} measurement shall |
| | be the Tx antenna connector of the UE. For FR2, the reference point for T_{UE-RX} |
| | measurement shall be the Rx antenna of the UE and the reference point for T_{UE-TX} |
| | measurement shall be the Tx antenna of the UE. |
| Applicable | RRC_CONNECTED intra-frequency |
| for | RRC_CONNECTED inter-frequency |

The integrity and reliability of the positioning estimate is defined by the following parameters: Alert Limit (AL); Time-to-Alert (TTA); Target Integrity Risk (TIR); Protection Level (PL).

The AL parameter indicates the maximum allowable positioning error such that the positioning system is available for the intended application. If the positioning error is beyond the AL parameter, operations are hazardous, and the positioning system should be declared unavailable for the intended application to prevent loss of integrity. Note that when the AL parameter bounds the positioning error in the horizontal plane or on the vertical axis, then it is called Horizontal Alert Limit (HAL) or Vertical Alert Limit (VAL), respectively.

The TTA parameter indicates the probability that the positioning error exceeds the AL parameter without warning the user within the required time defined by the TTA parameter.

The TIR parameter indicates the maximum allowable elapsed time from when the positioning error exceeds the AL parameter until the function providing position integrity annunciates a corresponding alert. Note that the TIR parameter is usually defined as a probability rate per some time unit (e.g., per hour, per second or per independent sample).

The PL parameter is a real-time upper bound on the positioning error at the required degree of confidence, where the degree of confidence is determined by the TIR probability. The PL is a statistical upper-bound of the Positioning Error (PE) that ensures that the probability per unit of time of the true error being greater than the AL and the PL being less than or equal to the AL, for longer than the TTA, is less than the required TIR, i.e., the PL satisfies the following inequality:

Prob per unit of time [((PE>AL) & (PL<=AL)) for longer than TTA]<required TIR

For the purposes of this disclosure, a positioning-related reference signal may be referred to as a reference signal used for positioning procedures/purposes in order to estimate a target-UE's location, e.g., PRS, or based on existing reference signals such as Channel State Information Reference Signal (CSI-RS) or Sounding Reference Signal (SRS); a target-UE may be referred to as the device/entity to be localized/positioned. In various embodiments, the term “PRS” may refer to any signal such as a reference signal, which may be used for positioning, even if the signal is not used primarily for positioning.

SL positioning techniques include, but are not limited to, RTT-type solutions using SL (to include both single-sided (also known as one-way) and double-sided (also known as two-way) RTT); Sidelink Angle-of-Arrival (SL-AoA) (to include both A-AoA and Z-AoA); SL-TDOA (makes use of the SL RSTD (and optionally SL PRS RSRP) of SL signals received from multiple TPs, at the UE); Sidelink Angle-of-Departure (SL-AoD) (corresponds to a method where RSRP and/or RSRPP measurements similar to the DL-AoD method in Uu, to include both Azimuth Angle-of-Departure (A-AoD) and Zenith Angle-of-Departure (Z-AoD)).

Regarding SL DRX operation, when SL DRX is configured, the Active Time includes the time: A) while sl-drx-onDurationTimer or sl-drx-InactivityTimer is running; or B) while sl-drx-RetransmissionTimer is running; or C) during the period of sl-LatencyBoundCSI-Report configured by RRC in case SL-CSI reporting MAC CE is not received; or D) while the time between the transmission of the request of SL-CSI reporting and the reception of the SL-CSI reporting MAC CE in case SL-CSI reporting MAC CE is received; or E) during a slot associated with the announced periodic transmissions by the UE transmitting SL-SCH Data.

When one or multiple SL DRX is configured, and if multiple SL DRX Cycles that are mapped with multiple SL-QoS-Profiles of a Destination Layer-2 ID and interested cast type is associated to groupcast or broadcast, then the MAC entity selects sl-drx-Cycle whose length of the sl-drx-cycle is the shortest one among multiple SL DRX Cycles that are mapped with multiple SL-QoS-Profiles associated with the Destination Layer-2 ID. Additionally, the MAC entity selects sl-drx-onDurationTimer whose length of the sl-drx-onDurationTimer is the longest one among multiple SL DRX onDuration timers that are mapped with multiple SL-QoS-Profiles associated with the Destination Layer-2 ID.

When one or multiple SL DRX is configured, and if an sl-drx-HARQ-RTT-Timer expires, then if the data of the corresponding Sidelink process was not successfully decoded or if the Hybrid Automated Repeat Request (“HARQ”) feedback (i.e., negative acknowledgement) is not transmitted for unicast due to UL/SL prioritization, then the MAC entity starts the sl-drx-Retransmission Timer for the corresponding Sidelink process in the first slot after the expiry of sl-drx-HARQ-RTT-Timer.

When the cast type is groupcast or broadcast as indicated by upper layer, the sl-drx-StartOffset and sl-drx-SlotOffset are derived from the following equations:

sl-drx-StartOffset (ms)=Destination Layer-2 ID modulo sl-drx-Cycle

sl-drx-SlotOffset (ms)=Destination Layer-2 ID modulo the number of slots in one subframe.

When the cast type is groupcast or broadcast, and if the SL DRX cycle is used, and [(SFN×10)+subframe number] modulo (sl-drx-Cycle)=sl-drx-StartOffset, then the MAC entity starts sl-drx-onDurationTimer after sl-drx-SlotOffset from the beginning of the subframe.

If an SL DRX is in Active Time, then the MAC entity monitors the SCI (i.e., 1^{st} stage SCI and 2^{nd} stage SCI) in this SL DRX. Then, if the SCI indicates a new SL transmission, and if the Source Layer-1 ID of the SCI is equal to the 8 Least Significant Bits (“LSB”) of the intended Destination Layer-2 ID and Destination Layer-1 ID of the SCI is equal to the 16 LSB of the intended Source Layer-2 ID and the cast type indicator in the SCI is set to unicast, then the MAC entity starts (or restarts) sl-drx-InactivityTimer for the corresponding Source Layer-2 ID and Destination Layer-2 ID pair after the first slot of SCI reception.

Further, if the SCI indicates a new SL transmission, and if the Destination Layer-1 ID of the SCI (i.e., 2^{nd} stage SCI) is equal to the 16 LSB of the intended Destination Layer-1 ID and the cast type indicator in the SCI is set to groupcast, then the MAC entity selects the sl-drx-InactivityTimer whose length is the largest one among multiple SL DRX Inactivity timers that are mapped to multiple SL-QoS-Profiles of Destination Layer-2 ID associated with the Destination Layer-1 ID of the SCI. Additionally, the MAC entity starts (or restarts) sl-drx-InactivityTimer for the corresponding Destination Layer-2 ID after the first slot of SCI reception.

When an SL DRX is in Active Time, and if the SCI indicates an SL transmission, then if a next retransmission opportunity is scheduled in the SCI, the MAC entity derives the sl-drx-HARQ-RTT-Timer from the retransmission resource timing of the next retransmission resource in the SCI. Else, the MAC entity uses the sl-drx-HARQ-RTT-Timer configured by upper layers.

When the SCI indicates an SL transmission, then if PSFCH resource is not configured for the SL grant associated to the SCI, then the MAC entity starts the sl-drx-HARQ-RTT-Timer for the corresponding Sidelink process in the slot following the end of PSSCH transmission (i.e., currently received PSSCH).

However, if a PSFCH resource is configured for the SL grant associated to the SCI, then if HARQ feedback is enabled by the SCI and the cast type indicator in the SCI is set to unicast, or if HARQ feedback is enabled by the SCI and the cast type indicator in the SCI is set to groupcast and positive-negative acknowledgement is selected, then the MAC entity starts the sl-drx-HARQ-RTT-Timer for the corresponding Sidelink process in the first slot after the end of the corresponding PSFCH transmission carrying the SL HARQ feedback. Alternatively, the MAC entity starts the sl-drx-HARQ-RTT-Timer for the corresponding Sidelink process in the first slot after the end of the corresponding PSFCH resource for the SL HARQ feedback when the SL HARQ feedback is not transmitted due to UL/SL prioritization.

When the PSFCH resource is configured for the SL grant associated to the SCI, if HARQ feedback is enabled by the SCI and the cast type indicator in the SCI is set to groupcast and negative-only acknowledgement is selected, then the MAC entity starts the sl-drx-HARQ-RTT-Timer for the corresponding Sidelink process in the first slot after the end of the corresponding PSFCH transmission carrying the SL HARQ feedback. Alternatively, the MAC entity starts the sl-drx-HARQ-RTT-Timer for the corresponding Sidelink process in the first slot after the end of the corresponding PSFCH resource for the SL HARQ feedback when the SL HARQ feedback is not transmitted due to UL/SL prioritization. Alternatively, the MAC entity starts the sl-drx-HARQ-RTT-Timer for the corresponding Sidelink process in the first slot after the end of the corresponding PSFCH resource for the SL HARQ feedback when the SL HARQ feedback is a positive acknowledgement.

When the PSFCH resource is configured for the SL grant associated to the SCI, then if HARQ feedback is disabled by the SCI and the resource(s) for one or more retransmission opportunities is not scheduled in the SCI, the MAC entity starts the sl-drx-HARQ-RTT-Timer for the corresponding Sidelink process in the slot following the end of PSFCH resource.

When the PSFCH resource is configured for the SL grant associated to the SCI, then if HARQ feedback is disabled by the SCI and the resource(s) for one or more retransmission opportunities is scheduled in the SCI, then the MAC entity starts the sl-drx-HARQ-RTT-Timer for the corresponding Sidelink process in the slot following the end of PSSCH transmission (i.e., currently received PSSCH). Further, the MAC entity stops the sl-drx-RetransmissionTimer for the corresponding Sidelink process.

When the cast type is groupcast or broadcast, if an SL DRX Command MAC CE is received for the Source Layer-2 ID and Destination Layer-2 ID pair of a unicast, then the MAC entity stops sl-drx-onDurationTimer for the Source Layer-2 ID and Destination Layer-2 ID pair of a unicast. Additionally, the MAC entity stops sl-drx-InactivityTimer for the Source Layer-2 ID and Destination Layer-2 ID pair of a unicast.

Regarding the UE behavior when transmitting SL-SCH Data during SL DRX operation, the UE transmitting SL-SCH Data should keep aligned with its intended UE receiving the SL-SCH Data regarding the SL DRX Active time as described above. Furthermore, the UE transmitting SL-SCH Data determines the SL DRX Active time based on SL DRX timers that are running (e.g., sl-drx-onDurationTimer, sl-drx-InactivityTimer, sl-drx-RetransmissionTimer) or will be running in the future (e.g., sl-drx-onDurationTimer, sl-drx-InactivityTimer, sl-drx-RetransmissionTimer) at the UE(s) receiving SL-SCH data.

The UE may select resource for the initial transmission of groupcast within the time when sl-drx-onDurationTimer or sl-drx-InactivityTimer of the destination is running. Note that a UE may assume that a resource for retransmission is in the Active time if an initial transmission causes the sl-drx-RetransmissionTimer to be started at the receiving UE.

According to current 3GPP specifications, the SL DRX operation would not cater for SL-PRS transmissions. This may lead to situation where UEs participating in a positioning session are not awake and ready to receive SL-PRS transmission from initiating UEs. On the other hand, if UEs participating in a sidelink positioning session would be always active and monitor for potential SL-PRS transmission would harm the battery drain. By extending the SL DRX scheme to also cater for SL-PRS transmission such negative effects can be avoided.

This present disclosure details solutions for enhancing the distributed resource allocation for UEs/devices performing SL positioning, especially considering positioning techniques which require the involvement of one or more UEs. An overview of the solutions is presented as follows:

In a first set of solutions, a UE considers the transmissions of SL-PRS as ActiveTime. The below solutions describe how a DRX configuration/timing is made known to the Rx UE. For example, for unicast there may be some link establishment procedure with exchange of SL-PRS configuration. The Tx UE tells Rx UE when it transmits the SL-PRS. The below solutions describe how the Rx UE may inform the Tx UE about its DRX configuration, in such embodiments, the Tx UE sends the SL-PRS within the ActiveTime. According to certain solutions, unicast SL-PRS are coordinated between a target UE and an anchor UE.

In another set of solutions, groupcast/broadcast SL-PRS could be treated like a service (i.e., corresponding to a predefined ActiveTime/DRX configuration). In certain solutions, the UEs treats DRX solutions for SL-PRS similar to data service. For example, there may a set of predefined SL-PRS DRX configurations, where the UE selects a particular solution based on required QoS/accuracy/method for the positioning service. In certain solutions, one DRX configuration may encompass SL-PRS to/from multiple UEs.

While presented as distinct solutions, one or more of the solutions described herein may be implemented in combination with each other to coordinate DRX operation with SL-PRS.

An initiator device, as used herein, initiates a SL positioning/ranging session, may be a network entity (e.g., gNB, LMF), a UE, and/or a roadside unit (“RSU”). A RSU refers to a transportation infrastructure entity (e.g., an entity transmitting speed notifications or other V2X-related notifications). An RSU performing UE-like behaviors is referred to as a UE-type RSU, while an RSU performing BS-like behaviors is referred to as a gNB-type RSU.

A responder device, as used herein, responds to a SL positioning/ranging session from an initiator device, may be a network entity, (e.g., gNB, LMF), a UE and/or an RSU.

A Target-UE, as used herein, refers to as a UE of interest whose position (absolute or relative) is to be obtained by the network and/or by the UE itself.

Sidelink positioning, as used herein, refers to using reference signals transmitted over SL, i.e., PC5 interface, to obtain absolute position, relative position, or ranging information.

Ranging, as used herein, refers to the determination of the distance and/or the direction between a UE and another entity, e.g., anchor UE.

SL-PRS, as used herein, refers to reference signal transmitted over SL for positioning purposes.

SL-PRS (pre-) configuration: (pre-) configured parameters of SL-PRS such as time-frequency resources (other parameters are not precluded) including its bandwidth and periodicity.

Anchor UE, as used herein, refers to a UE supporting positioning of a Target-UE, e.g., by transmitting and/or receiving reference signals for positioning, providing positioning-related information, etc., over the SL interface. An anchor UE may also be referred to as SL Reference UE.

Assistant UE, as used herein, refers to a UE supporting Ranging/Sidelink between a SL Reference UE and Target-UE over PC5, when the direct Ranging/Sidelink positioning between the SL Reference UE/Anchor UE and the Target-UE cannot be supported. The measurement/results of the Ranging/Sidelink Positioning between the Assistance UE and the SL Reference UE and that between the Assistance UE and the Target-UE are determined and used to derive the Ranging/Sidelink Positioning results between Target-UE and SL Reference UE.

SL Positioning Server UE, as used herein, refers to a UE offering location server functionality in lieu of LMF, for Sidelink Positioning and Ranging over Sidelink. It interacts with a Target-UE, Reference UEs, Assistant UE and Located UEs as necessary in order to calculate the location of the Target-UE.

SL Positioning Client UE, as used herein, refers to a UE offering location calculation, for SL Positioning and Ranging based service. It interacts with other UEs over PC5 as necessary in order to calculate the location of the Target-UE. The Target-UE or SL Reference UE can act as SL Positioning server UE if location calculation is supported.

SL positioning node, as used herein, may refer to a network entity and/or device/UE participating in a SL positioning session, e.g., LMF (location server), gNB, UE, RSU, anchor UE, Initiator and/or Responder UE.

Configuration entity, as used herein, refers to a network node or device/UE capable of configuring time-frequency resources and related SL positioning configurations.

With respect to a positioning session, it is assumed that the positioning server (e.g., SL Positioning Server UE) has received a location request for a given Target UE, which triggers the positioning session to be initiated. The positioning server may exchange messages with the Target UE—that is, lower protocol layers can provide the transport for the positioning protocol-level messages.

The first transaction of the positioning session is the capability exchange (e.g., LPP Request/Provide Capabilities). This information exchange makes the server aware of the UE positioning capabilities (GNSS support, supported cellular network measurements). Based on this information, the server can make a decision on the positioning method to be used, based on both UE capabilities and the requested quality-of-position (response time, accuracy). Similar to a PDU session (which is used for data transmission), the positioning session is used to support location based services.

The embodiments of the first solution relate to the adjusting of a DRX configuration for SL positioning. According to the first solution, one or more UEs participating a SL positioning session consider the time slots/symbols (or any time domain configuration) where SL-PRS transmissions are configured as DRX ActiveTime, e.g., a Rx UE (responder UE) shall be ready to receive SL-PRS from a Tx UE (or Initiator UE). According to one implementation of the first solution, the Rx UE considers the time slots where the Tx UE sends SL-PRS as ActiveTime.

In some embodiments, the Tx UE informs the Rx UE about the SL-PRS configuration/transmissions. For example, for Mode-1 SL-PRS resource allocation, the Tx UE may receive resource allocation for SL-PRS from a gNB (e.g., RAN node 208). In that case, the Tx UE forwards the SL resources/configuration for SL-PRS to the relevant Rx UE(s).

According to one implementation of the first solution, the Tx UE informs the Rx UE via a PC5 RRC message about the SL-PRS transmissions. In one example, the Tx UE uses a PC5-RRC message, e.g., RRCReconfigurationSidelink message, to inform a Rx UE about the SL-PRS configuration/transmission occasions. In another implementation of the first solution, a new positioning protocol message may be used to convey the SL-PRS configuration to the Rx UE. In one example, the Tx UE uses a Provide SLAssistance Data message to inform the Rx UE about the SL-PRS configuration/transmission occasions. In one embodiment, the positioning protocol used is the SL Positioning Protocol (“SLPP”). In another embodiment, the positioning protocol used is the Ranging SL Positioning Protocol (“RSPP”).

According to another implementation of the first solution, the Tx UE uses MAC control signaling in order to inform the Rx UE about future SL-PRS transmissions. In one example, a new MAC CE is introduced which carries the information about the upcoming SL-PRS transmissions. According to one aspect of the first solution, UE considers the SL resources indicated for reserved SL-PRS transmission as part of the Active Time.

According to another alternative implementation of the first solution, sidelink control information (“SCI”) indicates the presence of a corresponding SL-PRS transmission as well as information about future SL-PRS transmissions. In one example a one-bit field within the SCI indicates the SL resources and associated transmission parameters for the SL-PRS transmission. According to one implementation of the first solution, the new field set to ‘0’ indicates that the SCI carries control information on the associated PSSCH as in the legacy, whereas the field set to ‘1’ indicates that the control information refers to SL-PRS transmissions.

In one example, the SCI indicates information about reserved resources for further future SL-PRS transmissions.

The embodiments of the second solution relate to UE behavior with respect to DRX timers. According to the second solution, one or more UEs participating a SL positioning session do not start the sl-drx-InactivityTimer/sl-DRX-GC-InactivityTimer for cases that a SCI is received during ActiveTime determined by the SL-PRS transmission occasions. Different to the current defined DRX procedure, according to one implementation of the second solution, the Rx UE does not start the sl-drx-InactivityTimer/sl-DRX-GC-InactivityTimer in response to the reception of a SCI indicating the SL resources/transmission of SL-PRS (no SL data transmission indicated). Even though UE considers the slots where SL-PRS are expected from peer UEs as Active Time, a different DRX behavior is applied for those time slots which are part of the ActiveTime.

The embodiments of the third solution relate to the UE behavior with respect to SL transmission. According to the third solution, a SCI indicating the transmission of SL-PRS is not considered to as indicating a new SL transmission. The consequence of not considering a SCI indicating the transmission of SL-PRS as indicating a new SL transmission is that UE doesn't start the sl-drx-InactivityTimer/sl-DRX-GC-InactivityTimer in response to the reception of the SCI.

The embodiments of the fourth solution relate to UE behavior with respect to DRX timers. According to the fourth solution, the Rx UE does not start the sl-drx-HARQ-RTT-Timer in response to the reception of a SCI indicating the transmission of SL-PRS. Since no HARQ protocol is applied for SL-PRS transmissions, i.e., no SL-SCH/TB, there is no need to extend the Active Time by starting the sl-drx-HARQ-RTT-Timer respectively the sl-drx-RetransmissionTimer. According to the DRX procedure specified for Sidelink, a sl-drx-HARQ-RTT-Timer is maintained per HARQ process. However, SL-PRS transmission have no associated HARQ process.

The embodiments of the fifth solution relate to a gNB (or other network entity) configuring a set of DRX configuration for SL positioning. According to the fifth solution, a SL positioning UE E uses a predefined DRX pattern (e.g., configured by gNB) for reception/transmission of SL-PRS. The DRX pattern comprises an ActiveTime (or OnDuration), an idle time, an offset, and a number of transmission opportunities for SL-PRS. In one example, the predefined DRX pattern is configured per resource pool. In some embodiments, there may be a set of predefined DRX pattern used for SL-PRS, e.g., depending on required SL positioning QoS/accuracy of the associated positioning method and received SL positioning/ranging service request.

In one implementation of the fifth solution, a UE (e.g., Tx UE) determines the predefined DRX pattern based on the positioning accuracy, which is defined for different positioning methods. For example, SL positioning may be treated like a SL service with an associated QoS/accuracy requirements, where the associated QoS/accuracy requirements are used to select one of the DRX configurations from the set of predefined DRX configurations. In another implementation of the fifth solution, a UE (e.g., Tx UE) determines the predefined DRX pattern based on the required SL positioning latency to achieve the end-to-end absolute/relative positioning fix/estimate.

In a further implementation of the fifth solution, a UE (e.g., Tx UE) determines the predefined DRX pattern based on the required SL positioning reliability associated to, e.g., some integrity metrics such as PL, TTA, AL, or any other reliability metrics to ensure SL positioning reliability of the absolute/relative positioning fix/estimate. In other embodiments, the RAN informs the UEs which predefined DRX pattern to use, e.g., depending on required SL positioning QoS/accuracy of the associated positioning method and received SL positioning/ranging service request.

According to certain embodiments, each SL-PRS configuration is associated with an identifier/indicator which is used as a reference to positioning accuracy characteristics, e.g., also referred to as Accuracy QoS Indicator (“AQI”) in the following. In one implementation of the fifth solution, a UE (e.g., Tx UE) selects a predefined DRX pattern for the transmission/reception of SL-PRS which is selected based on the AQI of the corresponding SL-PRS transmission.

In one implementation of the fifth solution, the predefined DRX configuration is comprised of an OnDuration pattern and a slot/frame offset. In such embodiments, there is no need to have sl-drx-InactivityTimer configured in the predefined DRX configuration or other timers like sl-drx-RetransmissionTimer, etc.

The embodiments of the sixth solution relate to aligning a DRX configuration between SL positioning members. According to the sixth solution, a Target UE (e.g., which sends a SL positioning request) considers the time between the transmission of a request for SL-PRS reporting/transmission and the reception of the SL-PRS as ActiveTime. According to one implementation of the sixth solution, a Target UE transmitting a request for SL-PRS to one or multiple SL UEs, e.g., transmitting a MAC CE or SCI indicating the SL-PRS request, remains in ActiveTime subsequent to the transmission of the request until the reception of a SL-PRS.

The embodiments of the seventh solution relate to resource selection for SL positioning considering a DRX configuration. According to the seventh solution, a Tx UE selects SL resources for SL-PRS transmission within the ActiveTime of the destination/Rx UE. This means that the Tx UE, i.e., which is transmitting SL-PRS, and thus selecting SL resources in Mode-2 resource allocation, needs to consider the DRX configuration/Active Time of the destination UE to which it sends the SL-PRS. In other words, the Tx UE is only allowed to transmit during the active time of the Rx UE.

According to one implementation of the seventh solution, when the Tx UE performs the resource selection procedure for SL-PRS, it needs to consider the ActiveTime of the destination when selecting the SL resource for SL-PRS transmission, such that only SL resources which are within the ActiveTime of the destination are valid candidates for a SL-PRS transmission. In one example Tx UE determines the destination ID of the SL-PRS transmission. Accordingly, SL-PRS transmission will only occur within the ActiveTime of the destination UE.

According to one implementation of the seventh solution, the UE transmitting SL-PRS aligns its DRX configuration/ActiveTime with that of the destination UE receiving the SL-PRS. According to another implementation, a configuration entity, e.g., SL positioning server UE, LMF, gNB, is made aware about the ActiveTime configurations of the one or more multiple destination/responder UEs. Therefore, the configuration entity may inform UEs transmitting SL-PRS (e.g., anchor nodes, reference UEs, etc.) about the ActiveTime of the one or more multiple destination/responder UEs (e.g., Target-UEs).

The embodiments of the eighth solution relate to the MAC-layer DRX considerations for SL positioning. According to the eighth solution, the UE does not consider a SL-PRS transmission as a SL transmission from MAC layer point of view. According to current 3GPP standards, in the MAC layer it is specified that certain timers are to be triggered based on sidelink transmission and/or reception. For example, if a grant for SL transmission is received, then the SL UE will trigger certain DRX-related timers, including, but not limited to, the DRX timer, the HARQ retransmission timer, etc. Therefore, by not considering the SL-PRS as a SL transmission from MAC perspective (i.e., categorically ignoring SL-PRS as a type of SL transmission), the SL would not start the related timers. In certain embodiments, the eighth solution can be combined with other embodiments, e.g., the first solution).

Following the current defined DRX procedure (MAC layer procedure, TS 38.321) for sidelink certain actions are related to a SL transmission in the MAC layer, e.g., starting of specific DRX-related timers. When considering a SL-PRS transmission not as a sidelink transmission from MAC perspective, e.g., no TB/MAC PDU being involved for SL-PRS transmissions, the sidelink DRX procedure would be to a great extend agnostic to SL-PRS transmissions, e.g., SL DRX procedure is not impacted by SL-PRS transmissions.

The embodiments of the ninth solution relate to the UE not considering SL-PRS transmissions are not considered as DRX ActiveTime. In contrast to the first solution, here SL-PRS transmissions are not considered as DRX ActiveTime. In one embodiment, the SL-PRS transmission are treated similar to HARQ ACK/NACK transmissions. As used herein, “HARQ-ACK/NACK” may represent collectively the Positive Acknowledge (“ACK”) and the Negative Acknowledge (“NACK”), where ACK means that a Transport Block (“TB”) is correctly received while NACK means a TB is erroneously received. According to the ninth solution, the Tx UE informs the intended Rx UE(s) of the selected SL-PRS configuration and/or SL-PRS resources, such that the Rx UE(s) are made ready to receive SL-PRS transmission(s). However, from MAC layer or DRX point-of-view, the SL-PRS are not considered in a specific way.

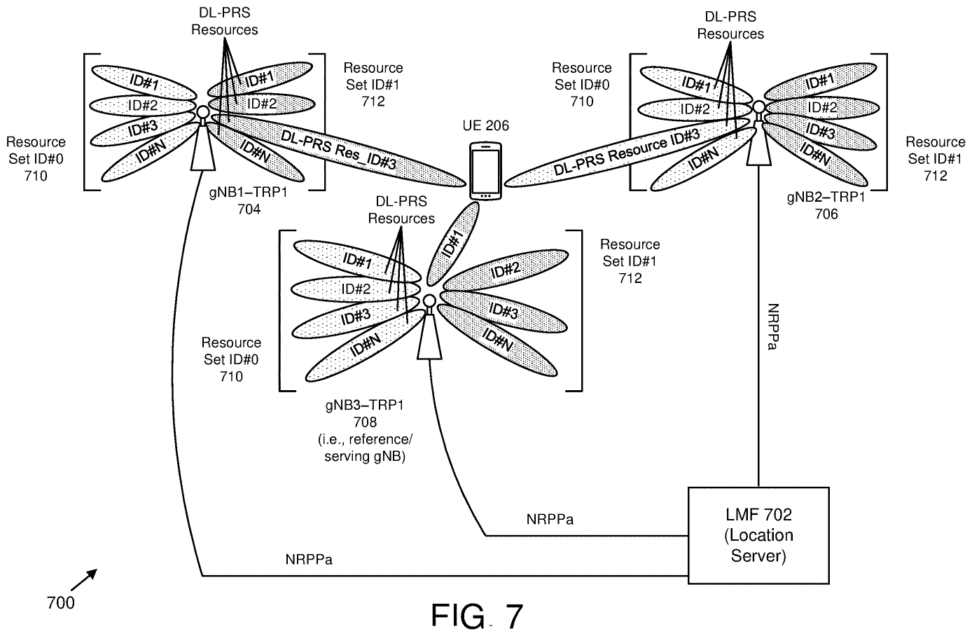

FIG. 8 illustrates an example of a UE 800 in accordance with aspects of the present disclosure. The UE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the UE 800 to perform various functions of the present disclosure.

The memory 804 may include volatile or non-volatile memory. The memory 804 may store computer-readable, computer-executable code including instructions when executed by the processor 802 cause the UE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the UE 800 to perform one or more of the Rx UE functions described herein (e.g., executing, by the processor 802, instructions stored in the memory 804). For example, the processor 802 may support wireless communication at the UE 800 in accordance with examples as disclosed herein. The UE 800 may be configured to support a means for participating in a positioning session with a set of UEs. Additionally, the processor 802 may configured the UE 800 with a DRX configuration including a DRX active time.

The UE 800 may be configured to support a means for receiving signaling information from at least one UE of the set of UEs. Here, the signaling information includes timing information for transmission of SL-PRS. In some implementations, the signaling information includes a MAC CE. In some implementations, the signaling information includes a RRC message. In some implementations, the signaling information includes a SL positioning protocol (e.g., SLPP, RSPP) message.

The UE 800 may be configured to support a means for considering the time periods (i.e., time slots/symbols) where SL-PRS transmissions are configured for as DRX ActiveTime by adjusting the DRX active time to include time periods corresponding to the transmission of SL-PRS subsequent to the reception of the signaling information.

In some implementations, the UE 800 may be configured to monitor for SCI during the time periods corresponding to the transmission of the SL-PRS received within the signaling information. In certain implementations, the SCI includes information about future SL-PRS transmissions. In certain implementations, the SCI includes a flag to indicate whether a corresponding SL resource is for non-positioning SL data or SL-PRS transmission.

In certain implementations, the UE 800 may be configured to consider the time periods where SL-PRS transmissions are configured for as DRX ActiveTime by suspending (or not starting) a timer subsequent to receiving SCI allocating sidelink resources for a SL-PRS transmission. In other implementations, the UE 800 may be configured to discontinue or rescind the timer upon receiving SCI is received that allocates resources for a SL-PRS transmission. In one implementation, the timer is a sl-drx-InactivityTimer. In another implementation, the timer is a sl-DRX-GC-InactivityTimer. In yet another implementation, the timer is a sl-drx-HARQ-RTT-Timer. In other implementations, the timer is a sl-drx-RetransmissionTimer.

In certain implementations, the UE 800 may be configured to consider the time periods where SL-PRS transmissions are configured for as DRX ActiveTime by disregarding SCI allocating sidelink resources for a SL-PRS transmission as indicating a SL transmission for DRX procedure. In some implementations, the UE 800 may be configured to disregard a SL-PRS transmission as a SL transmission that triggers MAC layer timers for DRX procedure.

In some implementations, the processor 802 and the memory 804 coupled with the processor 802 may be configured to cause the UE 800 to perform one or more of the Tx UE functions described herein (e.g., executing, by the processor 802, instructions stored in the memory 804). For example, the processor 802 may support wireless communication at the UE 800 in accordance with examples as disclosed herein. The UE 800 may be configured to support a means for initiating a positioning session with a set of UEs and a means for configuring a DRX configuration including a DRX active time.

The UE 800 may be configured to support a means for transmitting signaling information to at least one UE of the set of UEs, where the signaling information includes a request for transmission of SL-PRS. In some implementations, the signaling information includes a MAC CE. In certain implementations, the signaling information includes SCI.

The UE 800 may be configured to support a means for considering the time between the transmission of a request for SL-PRS reporting/transmission and the reception of the SL-PRS as ActiveTime by adjusting the DRX active time to include time periods (e.g., time slots/symbols) corresponding to the signaling information and a reception of SL-PRS.

In some implementations, the UE 800 may be configured to align the DRX active time with a corresponding active time configuration of the at least one UE. In some implementations, the UE 800 may be configured to select a set of SL resources for SL-PRS transmission within an active time of the at least one UE. In certain implementations, the UE 800 may be configured to receive information of an active time configuration of the set of UEs.

In some implementations, the UE 800 may be configured to transmit timing information for transmission of SL-PRS. In some implementations, the timing information is included in a MAC CE. In some implementations, the signaling information is included in an RRC message. In some implementations, the signaling information is included in an SL positioning protocol (e.g., SLPP, RSPP) message.

The controller 806 may manage input and output signals for the UE 800. The controller 806 may also manage peripherals not integrated into the UE 800. In some implementations, the controller 806 may utilize an operating system such as iOS®, ANDROID®, WINDOWS®, or other operating systems. In some implementations, the controller 806 may be implemented as part of the processor 802.

In some implementations, the UE 800 may include at least one transceiver 808. In some other implementations, the UE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receiving the signal over the air or wireless medium. The receiver chain 810 may include at least one amplifier (e.g., a low-noise amplifier (LNA)) configured to amplify the received signal. The receiver chain 810 may include at least one demodulator configured to demodulate the receiving signal and obtain the transmitted data by reversing the modulation technique applied during transmission of the signal. The receiver chain 810 may include at least one decoder for decoding and processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

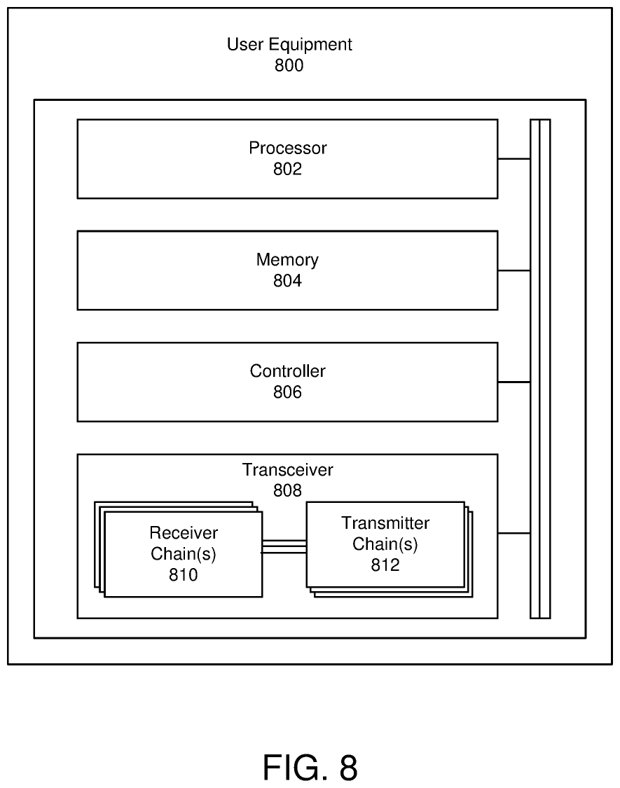

FIG. 9 illustrates an example of a processor 900 in accordance with aspects of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, which may be, for example, an L1/L2/L3 cache. Additionally, or alternatively, the processor 900 may optionally include one or more arithmetic-logic units (ALUs) 906. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory address of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, arithmetic logic units (ALUs), and other functional units of the processor 900.

The memory 904 may include one or more caches (e.g., memory local to or included in the processor 900 or other memory, such RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, the controller 902, and the memory 904 may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 906 may be configured to support various operations in accordance with examples as described herein. In some implementations, the one or more ALUs 906 may reside within or on a processor chipset (e.g., the processor 900). In some other implementations, the one or more ALUs 906 may reside external to the processor chipset (e.g., the processor 900). One or more ALUs 906 may perform one or more computations such as addition, subtraction, multiplication, and division on data. For example, one or more ALUs 906 may receive input operands and an operation code, which determines an operation to be executed. One or more ALUs 906 be configured with a variety of logical and arithmetic circuits, including adders, subtractors, shifters, and logic gates, to process and manipulate the data according to the operation. Additionally, or alternatively, the one or more ALUs 906 may support logical operations such as AND, OR, exclusive-OR (XOR), not-OR (NOR), and not-AND (NAND), enabling the one or more ALUs 906 to handle conditional operations, comparisons, and bitwise operations.

The processor 900 may support wireless communication in accordance with examples as disclosed herein. For example, the processor 900 may perform one or more of the Rx UE functions described herein. The processor 900 may be configured to or operable to support a means for participating in a positioning session with a set of UEs. Additionally, the processor 802 may be configured to or operable to support a means for set up a DRX configuration including a DRX active time.

The processor 900 may be configured to or operable to support a means for receiving signaling information from at least one UE of the set of UEs. Here, the signaling information includes timing information for transmission of SL-PRS. In some implementations, the signaling information includes a MAC CE. In some implementations, the signaling information includes a RRC message. In some implementations, the signaling information includes a SL positioning protocol (e.g., SLPP, RSPP) message.

The processor 900 may be configured to or operable to support a means for considering the time periods (i.e., time slots/symbols) where SL-PRS transmissions are configured for as DRX ActiveTime by adjusting the DRX active time to include time periods corresponding to the transmission of SL-PRS subsequent to the reception of the signaling information.

In some implementations, the processor 900 may be configured to or operable to monitor for SCI during the time periods corresponding to the transmission of the SL-PRS received within the signaling information. In certain implementations, the SCI includes information about future SL-PRS transmissions. In certain implementations, the SCI includes a flag to indicate whether a corresponding SL resource is for non-positioning SL data or SL-PRS transmission.

In certain implementations, the processor 900 may be configured to or operable to consider the time periods where SL-PRS transmissions are configured for as DRX ActiveTime by suspending (or not starting) a timer subsequent to receiving SCI allocating sidelink resources for a SL-PRS transmission. In other implementations, the processor 900 may be configured to or operable to discontinue or rescind the timer upon receiving SCI is received that allocates resources for a SL-PRS transmission. In one implementation, the timer is a sl-drx-InactivityTimer. In another implementation, the timer is a sl-DRX-GC-InactivityTimer. In yet another implementation, the timer is a sl-drx-HARQ-RTT-Timer. In other implementations, the timer is a sl-drx-RetransmissionTimer.

In certain implementations, the processor 900 may be configured to or operable to consider the time periods where SL-PRS transmissions are configured for as DRX ActiveTime by disregarding SCI allocating sidelink resources for a SL-PRS transmission as indicating a SL transmission for DRX procedure. In some implementations, the processor 900 may be configured to or operable to disregard a SL-PRS transmission as a SL transmission that triggers MAC layer timers for DRX procedure.

The processor 900 may perform one or more of the Tx UE functions described herein. The processor 900 may be configured to or operable to support a means for initiating a positioning session with a set of UEs and a means for configuring a DRX configuration including a DRX active time.

The processor 900 may be configured to or operable to support a means for transmitting signaling information to at least one UE of the set of UEs, where the signaling information includes a request for transmission of SL-PRS. In some implementations, the signaling information includes a MAC CE. In certain implementations, the signaling information includes SCI.

The processor 900 may be configured to or operable to support a means for considering the time between the transmission of a request for SL-PRS reporting/transmission and the reception of the SL-PRS as ActiveTime by adjusting the DRX active time to include time periods (e.g., time slots/symbols) corresponding to the signaling information and a reception of SL-PRS.

In some implementations, the processor 900 may be configured to or operable to align the DRX active time with a corresponding active time configuration of the at least one UE. In some implementations, the processor 900 may be configured to or operable to select a set of SL resources for SL-PRS transmission within an active time of the at least one UE. In certain implementations, the processor 900 may be configured to or operable to receive information of an active time configuration of the set of UEs.

In some implementations, the processor 900 may be configured to or operable to transmit timing information for transmission of SL-PRS. In some implementations, the timing information is included in a MAC CE. In some implementations, the signaling information is included in an RRC message. In some implementations, the signaling information is included in an SL positioning protocol (e.g., SLPP, RSPP) message.

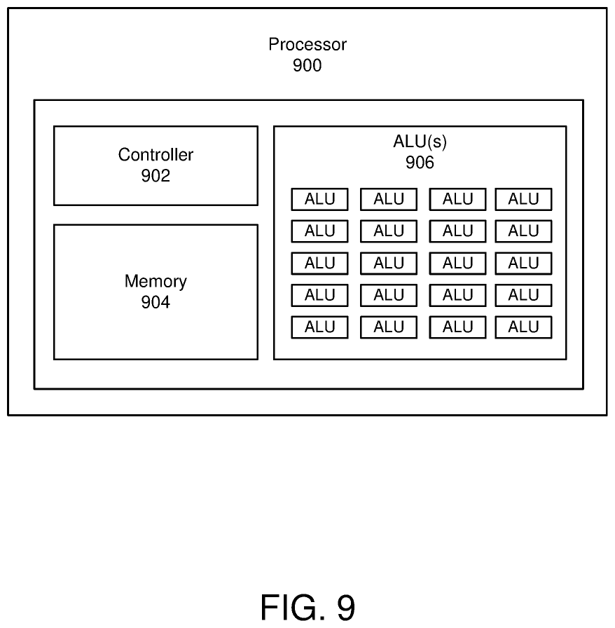

FIG. 10 illustrates an example of a NE 1000 in accordance with aspects of the present disclosure. The NE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the NE 1000 to perform various functions of the present disclosure.

The memory 1004 may include volatile or non-volatile memory. The memory 1004 may store computer-readable, computer-executable code including instructions when executed by the processor 1002 cause the NE 1000 to perform various functions described herein. The code may be stored in a non-transitory computer-readable medium such the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the NE 1000 to perform one or more of the functions described herein (e.g., executing, by the processor 1002, instructions stored in the memory 1004). For example, the processor 1002 may support wireless communication at the NE 1000 in accordance with examples as disclosed herein. The NE 1000 may be configured to support a means for configuring a set of DRX configurations for transmission of SL-PRS. In some implementations, the set of DRX configurations is configured per resource pool. In some implementations, a particular DRX configuration includes an active time, and idle time, an offset, and a number of transmissions.

In some implementations, the NE 1000 may be configured to institute the set of DRX configuration based on a SL positioning accuracy requirement. In some implementations, the NE 1000 may be configured to institute the set of DRX configuration based on a SL positioning QoS requirement of an associated positioning method.

The NE 1000 may be configured to support a means for allocating a set of SL time-frequency resources to a set of UEs for a positioning session. Note that the NE 1000 configures the UEs with the set of DRX configurations and a respective UE selects one of the DRX configuration from the set of DRX configurations based on the SL positioning QoS requirements.

In some implementations, the NE 1000 may be configured to acquire information of an active time configuration of the set of UEs and transmits the information to an initiator UE of the set of UEs.

The controller 1006 may manage input and output signals for the NE 1000. The controller 1006 may also manage peripherals not integrated into the NE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the NE 1000 may include at least one transceiver 1008. In some other implementations, the NE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas for receiving the signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receiving signal and obtain the transmitted data by reversing the modulation technique applied during transmission of the signal. The receiver chain 1010 may include at least one decoder for decoding and processing the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

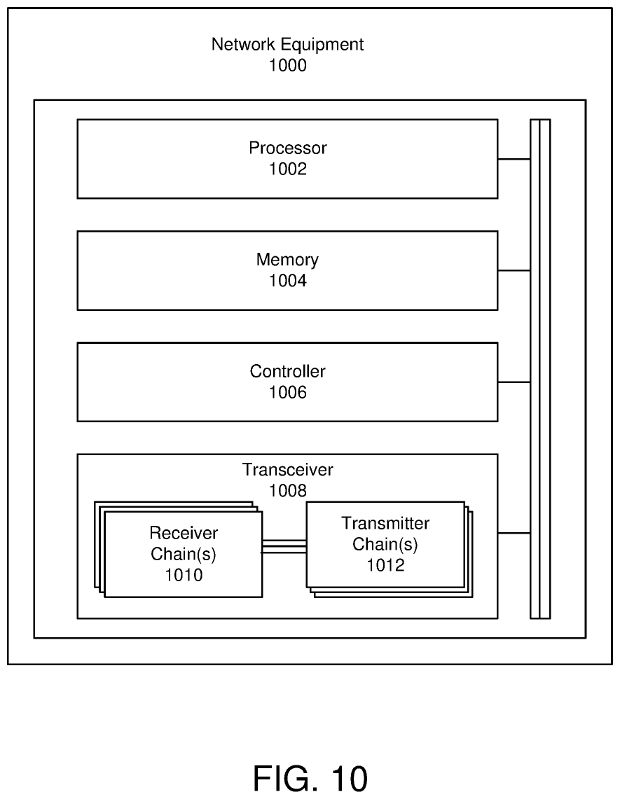

FIG. 11 illustrates a flowchart of a method 1100 in accordance with aspects of the present disclosure. The operations of the method 1100 may be implemented by a Rx UE as described herein. In some implementations, the Rx UE may execute a set of instructions to control the function elements of the Rx UE to perform the described functions.

At Step 1102, the method 1100 may include receiving a CSI reporting setting. The operations of Step 1102 may be performed in accordance with examples as described herein. In some implementations, aspects of the operations of Step 1102 may be performed by a Rx UE as described with reference to FIG. 8.

At Step 1104, the method 1100 may include receiving a set of channel measurement reference signals comprising at least one NZP CSI-RS resource. The operations of Step 1104 may be performed in accordance with examples as described herein. In some implementations, aspects of the operations of Step 1104 may be performed by an Rx UE as described with reference to FIG. 8.

At Step 1106, the method 1100 may include generating CSI feedback report comprising a plurality of CSI report segments and a plurality of CQI values associated with the plurality of CSI report segments, in accordance with the CSI reporting setting. The operations of Step 1106 may be performed in accordance with examples as described herein. In some implementations, aspects of the operations of Step 1106 may be performed a Rx UE as described with reference to FIG. 8.

At Step 1108, the method 1100 may include transmitting the CSI feedback report. The operations of Step 1108 may be performed in accordance with examples as described herein. In some implementations, aspects of the operations of Step 1108 may be performed a Rx UE as described with reference to FIG. 8.

It should be noted that the method 1100 described herein describes one possible implementation, and that the operations and the steps may be rearranged or otherwise modified and that other implementations are possible.

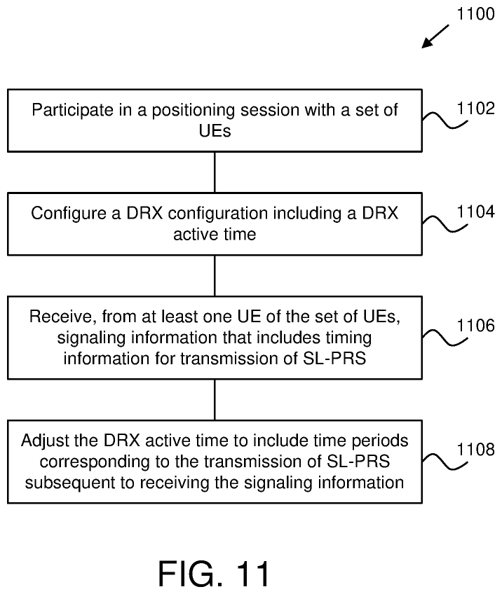

FIG. 12 illustrates a flowchart of a method 1200 in accordance with aspects of the present disclosure. The operations of the method 1200 may be implemented by a Rx UE as described herein. In some implementations, the Rx UE may execute a set of instructions to control the function elements of the Rx UE to perform the described functions.

At Step 1202, the method 1200 may include participating in a positioning session with a set of UEs. The operations of Step 1202 may be performed in accordance with examples as described herein. In some implementations, aspects of the operations of Step 1202 may be performed by a Rx UE as described with reference to FIG. 8.

At Step 1204, the method 1200 may include configuring a DRX configuration including a DRX active time. The operations of Step 1204 may be performed in accordance with examples as described herein. In some implementations, aspects of the operations of Step 1204 may be performed by an Rx UE as described with reference to FIG. 8.

At Step 1206, the method 1200 may include receiving, from at least one UE of the set of UEs, signaling information that includes timing information for transmission of SL-PRS. The operations of Step 1206 may be performed in accordance with examples as described herein. In some implementations, aspects of the operations of Step 1206 may be performed a Rx UE as described with reference to FIG. 8.

At Step 1208, the method 1200 may include adjusting the DRX active time to include time periods corresponding to the transmission of SL-PRS subsequent to the reception of the signaling information. The operations of Step 1208 may be performed in accordance with examples as described herein. In some implementations, aspects of the operations of Step 1208 may be performed a Rx UE as described with reference to FIG. 8.

At Step 1210, the method 1200 may include monitoring for SCI during the time periods corresponding to the transmission of the SL-PRS received. The operations of Step 1210 may be performed in accordance with examples as described herein. In some implementations, aspects of the operations of Step 1210 may be performed by an Rx UE as described with reference to FIG. 8.

At Step 1212, the method 1200 may optionally include suspending a timer in response to receiving SCI allocating sidelink resources for a SL-PRS transmission. The operations of Step 1212 may be performed in accordance with examples as described herein. In some implementations, aspects of the operations of Step 1212 may be performed a Rx UE as described with reference to FIG. 8.

At Step 1214, the method 1200 may optionally include includes disregard SCI allocating sidelink resources for a SL-PRS transmission as indicating a SL transmission for DRX procedure. The operations of Step 1214 may be performed in accordance with examples as described herein. In some implementations, aspects of the operations of Step 1214 may be performed a Rx UE as described with reference to FIG. 8.

It should be noted that the method 1200 described herein describes one possible implementation, and that the operations and the steps may be rearranged or otherwise modified and that other implementations are possible.

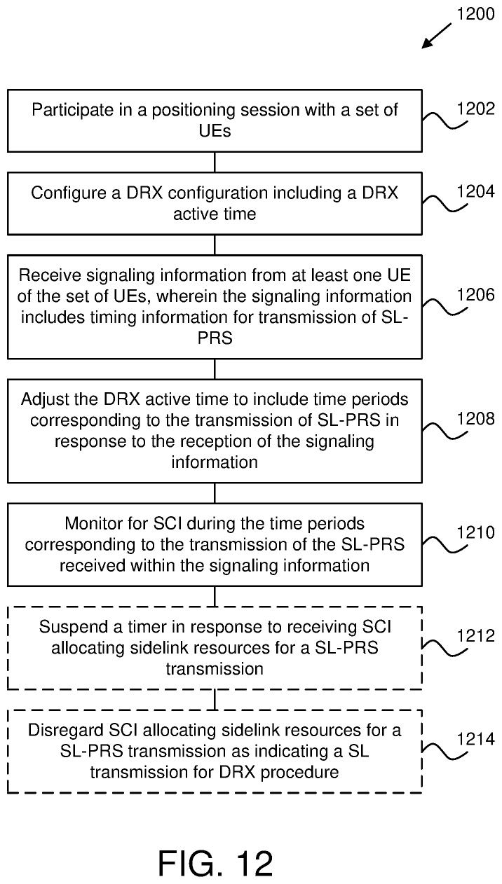

FIG. 13 illustrates a flowchart of a method 1300 in accordance with aspects of the present disclosure. The operations of the method 1300 may be implemented by a Rx UE as described herein. In some implementations, the Rx UE may execute a set of instructions to control the function elements of the Rx UE to perform the described functions.

At Step 1302, the method 1300 may include participating in a positioning session with a set of UEs. The operations of Step 1302 may be performed in accordance with examples as described herein. In some implementations, aspects of the operations of Step 1302 may be performed by a Rx UE as described with reference to FIG. 8.

At Step 1304, the method 1300 may include configuring a DRX configuration including a DRX active time. The operations of Step 1304 may be performed in accordance with examples as described herein. In some implementations, aspects of the operations of Step 1304 may be performed by an Rx UE as described with reference to FIG. 8.

At Step 1306, the method 1300 may include receiving, from at least one UE of the set of UEs, signaling information that includes timing information for transmission of SL-PRS. The operations of Step 1306 may be performed in accordance with examples as described herein. In some implementations, aspects of the operations of Step 1306 may be performed a Rx UE as described with reference to FIG. 8.

At Step 1308, the method 1300 may include adjusting the DRX active time to include time periods corresponding to the transmission of SL-PRS subsequent to the reception of the signaling information. The operations of Step 1308 may be performed in accordance with examples as described herein. In some implementations, aspects of the operations of Step 1308 may be performed a Rx UE as described with reference to FIG. 8.

At Step 1310, the method 1300 may include disregarding (i.e., not considering) a SL-PRS transmission as a SL transmission that triggers MAC layer timers for DRX procedure. The operations of Step 1310 may be performed in accordance with examples as described herein. In some implementations, aspects of the operations of Step 1310 may be performed by an Rx UE as described with reference to FIG. 8.

It should be noted that the method 1300 described herein describes one possible implementation, and that the operations and the steps may be rearranged or otherwise modified and that other implementations are possible.

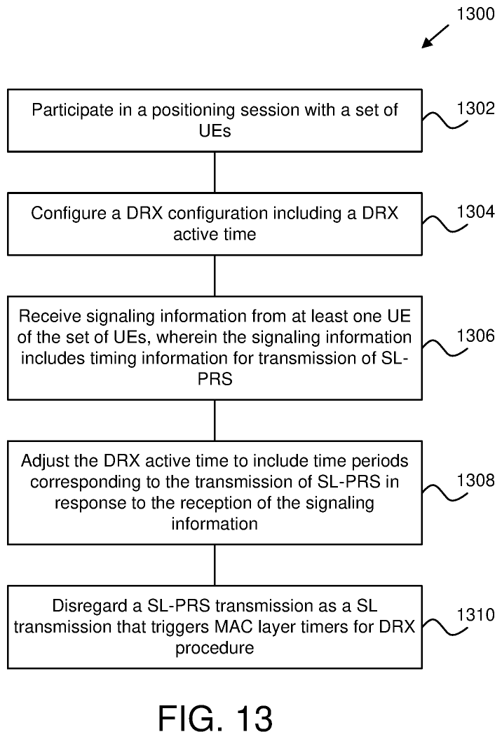

FIG. 14 illustrates a flowchart of a method 1400 in accordance with aspects of the present disclosure. The operations of the method 1400 may be implemented by a Tx UE as described herein. In some implementations, the Tx UE may execute a set of instructions to control the function elements of the Tx UE to perform the described functions.

At Step 1402, the method 1400 may include initiating a positioning session with a set of UEs. The operations of Step 1402 may be performed in accordance with examples as described herein. In some implementations, aspects of the operations of Step 1402 may be performed by a Tx UE as described with reference to FIG. 8.

At Step 1404, the method 1400 may include configuring a DRX configuration including a DRX active time. The operations of Step 1404 may be performed in accordance with examples as described herein. In some implementations, aspects of the operations of Step 1404 may be performed by an Tx UE as described with reference to FIG. 8.

At Step 1406, the method 1400 may include transmitting signaling information to at least one UE of the set of UEs, where the signaling information includes a request for transmission of SL-PRS. The operations of Step 1406 may be performed in accordance with examples as described herein. In some implementations, aspects of the operations of Step 1406 may be performed a Tx UE as described with reference to FIG. 8.

At Step 1408, the method 1400 may include adjusting the DRX active time to include time periods corresponding to the signaling information and a reception of SL-PRS. The operations of Step 1408 may be performed in accordance with examples as described herein. In some implementations, aspects of the operations of Step 1408 may be performed a Tx UE as described with reference to FIG. 8.

It should be noted that the method 1400 described herein describes one possible implementation, and that the operations and the steps may be rearranged or otherwise modified and that other implementations are possible.

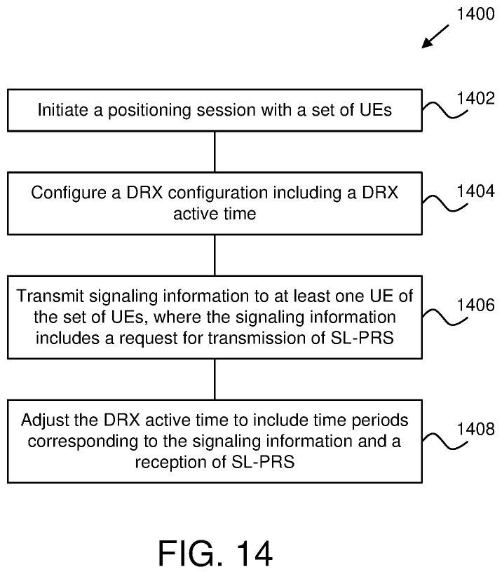

FIG. 15 illustrates a flowchart of a method 1500 in accordance with aspects of the present disclosure. The operations of the method 1500 may be implemented by a Tx UE as described herein. In some implementations, the Tx UE may execute a set of instructions to control the function elements of the Tx UE to perform the described functions.

At Step 1502, the method 1500 may include initiating a positioning session with a set of UEs. The operations of Step 1502 may be performed in accordance with examples as described herein. In some implementations, aspects of the operations of Step 1502 may be performed by a Tx UE as described with reference to FIG. 8.

At Step 1504, the method 1500 may include configuring a DRX configuration including a DRX active time. The operations of Step 1504 may be performed in accordance with examples as described herein. In some implementations, aspects of the operations of Step 1504 may be performed by an Tx UE as described with reference to FIG. 8.

At Step 1506, the method 1500 may include transmitting signaling information to at least one UE of the set of UEs, where the signaling information includes a request for transmission of SL-PRS. The operations of Step 1506 may be performed in accordance with examples as described herein. In some implementations, aspects of the operations of Step 1506 may be performed a Tx UE as described with reference to FIG. 8.

At Step 1508, the method 1500 may include adjusting the DRX active time to include time periods corresponding to the signaling information and a reception of SL-PRS. The operations of Step 1508 may be performed in accordance with examples as described herein. In some implementations, aspects of the operations of Step 1508 may be performed a Tx UE as described with reference to FIG. 8.

At Step 1510, the method 1500 may include aligning the DRX active time with a corresponding active time configuration of the at least one UE. The operations of Step 1510 may be performed in accordance with examples as described herein. In some implementations, aspects of the operations of Step 1510 may be performed by an Tx UE as described with reference to FIG. 8.

At Step 1512, the method 1500 may optionally include receiving information of an active time configuration of the set of UEs. The operations of Step 1512 may be performed in accordance with examples as described herein. In some implementations, aspects of the operations of Step 1512 may be performed by a Tx UE as described with reference to FIG. 8.

At Step 1514, the method 1500 may optionally include selecting a set of SL resources for SL-PRS transmission within an active time of the at least one UE. The operations of

Step 1514 may be performed in accordance with examples as described herein. In some implementations, aspects of the operations of Step 1514 may be performed by an Tx UE as described with reference to FIG. 8.

It should be noted that the method 1500 described herein describes one possible implementation, and that the operations and the steps may be rearranged or otherwise modified and that other implementations are possible.

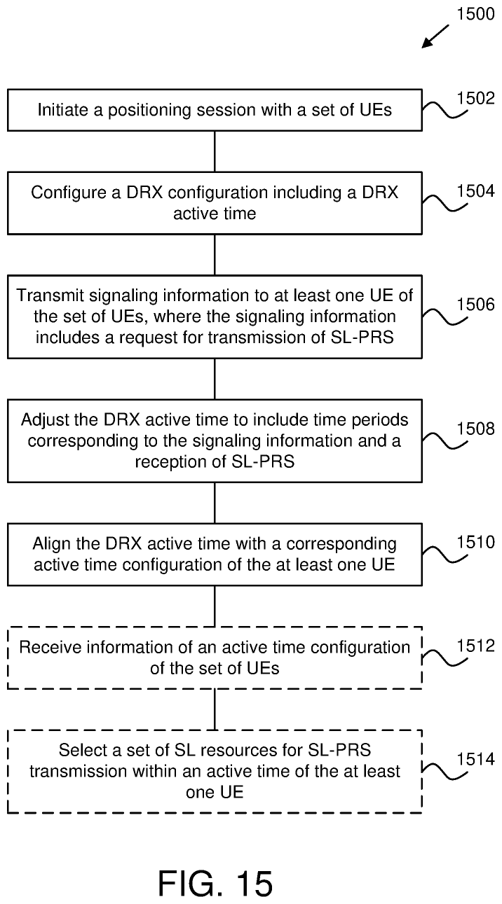

FIG. 16 illustrates a flowchart of a method 1600 in accordance with aspects of the present disclosure. The operations of the method 1600 may be implemented by a NE as described herein. In some implementations, the NE may execute a set of instructions to control the function elements of the NE to perform the described functions.

At Step 1602, the method 1600 may include configuring a set of DRX configurations for transmission of SL-PRS. The operations of Step 1602 may be performed in accordance with examples as described herein. In some implementations, aspects of the operations of Step 1602 may be performed by a NE as described with reference to FIG. 10.

At Step 1604, the method 1600 may include allocating a set of SL time-frequency resources to a set of UEs for a positioning session. The operations of Step 1604 may be performed in accordance with examples as described herein. In some implementations, aspects of the operations of Step 1604 may be performed by an NE as described with reference to FIG. 10.

It should be noted that the method 1600 described herein describes one possible implementation, and that the operations and the steps may be rearranged or otherwise modified and that other implementations are possible.

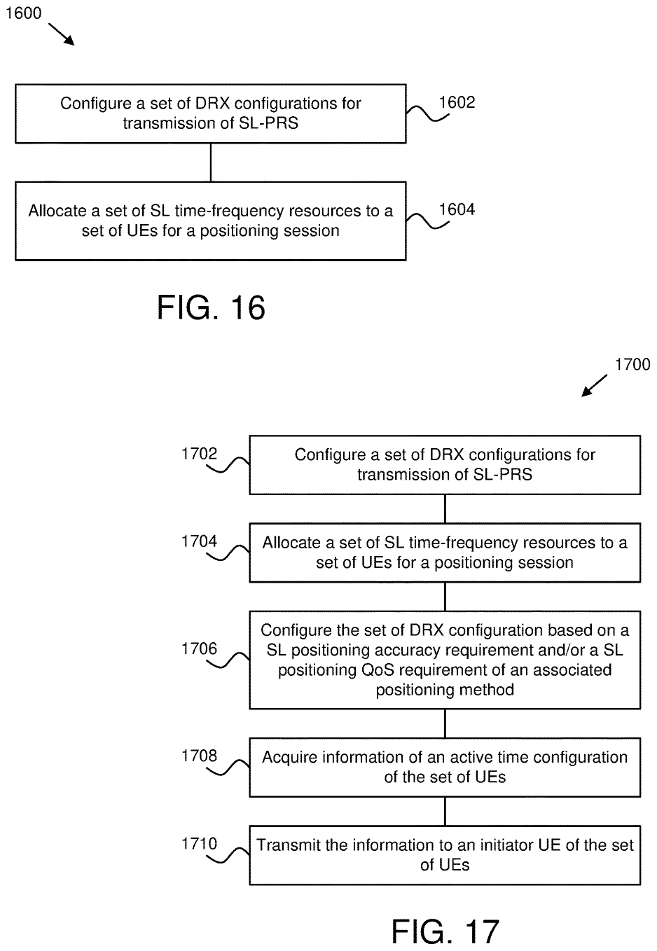

FIG. 17 illustrates a flowchart of a method 1700 in accordance with aspects of the present disclosure. The operations of the method 1700 may be implemented by a NE as described herein. In some implementations, the NE may execute a set of instructions to control the function elements of the NE to perform the described functions.

At Step 1702, the method 1700 may include configuring a set of DRX configurations for transmission of SL-PRS. The operations of Step 1702 may be performed in accordance with examples as described herein. In some implementations, aspects of the operations of Step 1702 may be performed by a NE as described with reference to FIG. 10.

At Step 1704, the method 1700 may include allocating a set of SL time-frequency resources to a set of UEs for a positioning session. The operations of Step 1704 may be performed in accordance with examples as described herein. In some implementations, aspects of the operations of Step 1704 may be performed by an NE as described with reference to FIG. 10.

At Step 1706, the method 1700 may include configuring the set of DRX configurations based on a SL positioning accuracy requirement and/or a SL positioning QoS requirement of an associated positioning technique. The operations of Step 1706 may be performed in accordance with examples as described herein. In some implementations, aspects of the operations of Step 1706 may be performed a NE as described with reference to FIG. 10.

At Step 1708, the method 1700 may include acquiring information of an active time configuration of the set of UEs. The operations of Step 1708 may be performed in accordance with examples as described herein. In some implementations, aspects of the operations of Step 1708 may be performed a NE as described with reference to FIG. 10.

At Step 1710, the method 1700 may include transmitting the information to an initiator UE of the set of UEs. The operations of Step 1710 may be performed in accordance with examples as described herein. In some implementations, aspects of the operations of Step 1710 may be performed by an NE as described with reference to FIG. 10.

It should be noted that the method 1700 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
configure a discontinuous reception (DRX) configuration comprising a DRX active time;
receive timing information for transmission of sidelink positioning reference signals (SL-PRS); and
adjust the DRX active time to include time periods corresponding to the transmission of SL-PRS.

2. The UE of claim 1, wherein the timing information is received via one or more of a Medium Access Control (MAC) Control Element (CE), or a Radio Resource Control (RRC) message, or a sidelink (SL) positioning protocol message.

3. The UE of claim 1, wherein the at least one processor is configured to cause the UE to monitor for sidelink control information (SCI) during the time periods corresponding to the transmission of SL-PRS.

4. The UE of claim 3, wherein the SCI comprises information about future SL-PRS transmissions.

5. The UE of claim 3, wherein the SCI comprises a flag to indicate whether a corresponding sidelink (SL) resource is for non-positioning SL data or SL-PRS transmission.

6. The UE of claim 3, wherein the at least one processor is configured to cause the UE to suspend a timer in response to receiving the received SCI allocating sidelink resources for a SL-PRS transmission.

7. The UE of claim 6, wherein the timer comprises one or more of a sl-drx-InactivityTimer, a sl-DRX-GC-InactivityTimer, a sl-drx-HARQ-RTT-Timer, or a sl-drx-RetransmissionTimer.

8. The UE of claim 3, wherein the at least one processor is configured to cause the UE to disregard SCI allocating sidelink resources for a SL-PRS transmission as indicating a sidelink (SL) transmission for DRX procedure.

9. The UE of claim 1, wherein the at least one processor is configured to cause the UE to disregard a SL-PRS transmission as a sidelink (SL) transmission that triggers Medium Access Control (MAC) layer timers for a DRX procedure.

10. A method performed by a user equipment (UE), the method comprising:
configuring a discontinuous reception (DRX) configuration comprising a DRX active time;
receiving timing information for transmission of sidelink positioning reference signals (SL-PRS); and
adjusting the DRX active time to include time periods corresponding to the transmission of SL-PRS.

11. A user equipment (UE) for wireless communication, comprising:
at least one memory; and
at least one processor coupled with the at least one memory and configured to cause the UE to:
configure a discontinuous reception (DRX) configuration comprising a DRX active time;
transmit, to at least one UE of a set of UEs, a request for transmission of sidelink positioning reference signals (SL-PRS); and
adjust the DRX active time to include time periods corresponding to the transmission of SL-PRS.

12. The UE of claim 11, wherein the timing information is transmitted via one or more of a Medium Access Control (MAC) Control Element (CE) or sidelink control information (SCI).

13. The UE of claim 11, wherein the at least one processor is configured to cause the UE to select a set of sidelink (SL) resources for SL-PRS transmission within an active time of the at least one UE.

14. The UE of claim 13, wherein the at least one processor is configured to cause the UE to receive a configuration that indicates one or more active times of the set of UEs.

15. The UE of claim 11, wherein the at least one processor is configured to cause the UE to align the DRX active time with a corresponding active time of the at least one UE.

16. A base station for wireless communication, comprising:
at least one memory; and
at least one processor coupled with the at least one memory and configured to cause the base station to:
configure a set of discontinuous reception (DRX) configurations for transmission of sidelink positioning reference signals (SL-PRS); and
allocate a set of sidelink (SL) time-frequency resources to a set of User Equipments (UEs) for a positioning session.

17. The base station of claim 16, wherein the set of DRX configurations is configured per resource pool.

18. The base station of claim 16, wherein a DRX configuration of the set of DRX configurations comprises one or more of an active time, an idle time, an offset, and a number of transmissions.

19. The base station of claim 16, wherein the at least one processor is configured to cause the base station to configure the set of DRX configuration based on a SL positioning accuracy requirement or a SL positioning Quality of Service (QoS) requirement of an associated positioning method.

20. The base station of claim 16, wherein the at least one processor is configured to cause the base station to:
acquire a configuration that indicates one or more active times of the set of UEs; and
transmit information indicative of the one or more active time to an initiator UE of the set of UEs.
